(19) United States
(12) Patent Application Publication
(10) Pub. No.: US 2026/0127828 A1
(43) Pub. Date: May 7, 2026

(54) SYSTEM AND METHOD FOR DISPLAYING AUGMENTED-REALITY OBJECTS

(71) Applicant: SUPERIOR INNOVAATIO LLC, Marquette, MI (US)

(72) Inventors: Vincent Nystrom, Marquette, MI (US); Joe Thiel, Marquette, MI (US)

(21) Appl. No.: 19/378,623

(22) Filed: Nov. 4, 2025

Related U.S. Application Data
(60) Provisional application No. 63/715,804, filed on Nov. 4, 2024.

(51) Int. Cl. G06T 19/00; G06T 15/50; G06T 15/80; G06T 19/20

(52) U.S. Cl. CPC G06T 19/006; G06T 15/506; G06T 15/80; G06T 19/20; G06T 2219/2004; G06T 2219/2016

(57) ABSTRACT

Ways for displaying an augmented-reality object on drinkware within digital video content are provided that include an imaging device to capture digital video content, a processor, and a memory in communication with the processor. The memory includes a detection module, an orientation module, and a rendering module that work together to provide real-time augmented reality functionality. The detection module receives the digital video content from the imaging device, identifies a visual object within the digital video content as drinkware, and identifies a surface of the drinkware. The orientation module analyzes the drinkware to determine when the drinkware can be tilted to an image-generating position where the surface of the drinkware can be viewable in the digital video content. The rendering module overlays an augmented-reality object onto the surface of the drinkware when an orientation of the drinkware meets a predetermined angular threshold relative to the imaging device.

### CROSS-REFERENCE TO RELATED APPLICATIONS

This application claims the benefit of U.S. Provisional Application No. 63/715,804, filed on November 04, 2024. The entire disclosure of the above application is incorporated herein by reference.

### FIELD

The present technology relates to augmented reality systems and methods for processing digital video content, and, more particularly, to systems utilizing object recognition algorithms to detect objects within video streams and apply augmented reality overlays based on object orientation.

### INTRODUCTION

This section provides background information related to the present disclosure which is not necessarily prior art.

Advancements in augmented reality (AR) technology have transformed how users can interact with digital content, merging real-world environments with computer-generated information. AR systems can overlay digital elements, such as text, images, or animations, onto a video view of the physical world through devices like computers, smartphones, tablets, or AR headsets. This enhanced interaction can blur the lines between physical and digital realms, enabling more immersive and engaging experiences. However, certain AR systems face challenges in optimizing object recognition accuracy, real-time processing, and scalability, particularly in varying lighting conditions, occlusion, intra-class variation, viewpoint variation, and complex environments.

One of the components driving the evolution of AR systems can be object recognition, the process of identifying and classifying objects within a video stream or live environment. Through machine learning algorithms, particularly computer vision, AR systems can detect, track, and analyze objects in real-time, facilitating the integration of digital content onto physical objects or spaces within photo or video media. Certain object recognition applications, however, cannot determine an object's rotation, or the camera's viewpoint of the object based on specific features of the object in video media, creating a visual disconnect between the object and the image superimposed on the object when the object changes in orientation, rotation, or angle. This visual disconnect between the object and the superimposed image amplifies the cartoonish or unrealistic nature of certain AR applications.

Video-based AR systems can utilize image processing and object recognition to enhance user interaction, allowing AR platforms to recognize specific objects or environments and augment them with relevant data, graphics, or 3D models. In some cases, an AR-enabled mobile device can recognize a silhouette of a person and augment the background within the area outside of the silhouette. In certain cases, AR-enabled devices can recognize a human face within a photo or video media and overlay features such as cartoon animal facial features over part or all of the face. In these AR systems, the cartoonish, or unrealistic, nature of the face-based virtual objects can lack accuracy of the size, shape, orientation, and placement of the virtual objects relative to the real-world objects. Certain AR systems must balance computational power, latency, and user experience to deliver smooth, real-time interactions.

Electronic devices, including smartphones, tablet computers, and laptop computers, can be equipped to engage in videoconferences with other electronic devices across a network. Users employ such devices to communicate with friends, family, and work colleagues. During videoconferences, people can select "virtual" background images in an effort to make meetings more fun and engaging. These virtual backgrounds also work to protect privacy, such as when the original background replaces what might be an image of a personal space, such as a messy room, behind the participant. While virtual backgrounds can be interesting features available in videoconferencing software, selecting and changing them can be an incredibly tedious process. A user must either resort to a boring "default" option, which still takes many keystrokes and mouse movements to select, or requires a user to hunt and search for a desired virtual background for display.

Videoconferencing systems can present background and overlay indicia in a videoconference, focusing on automatically applying virtual background or overlay indicia behind a subject or on other parts of the video feed based on contextual information detected during the videoconference. This technology can simplify and enhance the videoconferencing experience by integrating dynamic background elements and overlays that respond to the context of the videoconference, such as the location, time, or specific events mentioned during the call. However, these systems can primarily concern methods for presenting background and overlay indicia that enhance the videoconferencing environment itself with context-sensitive backgrounds and overlays, rather than focusing on specific physical objects within the video feed. Certain systems can focus on themes for virtual collaboration, which involves modifying the visual properties of graphical user interfaces during virtual video sessions, but cannot explicitly detail the use of artificial intelligence (AI) for object detection within the video content.

Certain communication systems can allow two devices at different locations to connect and communicate with each other, where a device obtains connection information from another device at its location and transmits it to a second device. These systems can primarily focus on improving communication systems by facilitating the transmission and management of data across different terminals and platforms, involving methods and systems that enhance the efficiency and reliability of data transmission in communication networks. Certain systems can detail mechanisms for managing data packets, reducing errors, and ensuring that communication remains stable and efficient across various devices and network conditions, but can only focus on the technical backend of communication systems rather than enhancing the visual or interactive aspects of user interfaces or video feeds. Certain systems can allow participants in a live share to annotate live audio-video content in real-time but not allow interactive advertising or gamification.

There is a continuing need for improved systems and methods for detecting specific objects within digital video content and superimposing images directly onto these objects when tilted within optimal viewability. Desirably, such systems and methods would overcome limitations in object recognition by providing dynamic and intuitive ways for presenting contextual information while maintaining a professional aesthetic, particularly in videoconferencing settings where accurate object detection, real-time processing, and realistic visual integration can be needed to enhance user engagement through seamless integration of promotional or informational content.

### SUMMARY

In concordance with the instant disclosure, improved systems and methods for detecting specific objects within digital video content and superimposing images directly onto these objects when tilted within optimal viewability, have surprisingly been discovered.

The present technology includes systems and processes that relate to augmented reality applications and computer-implemented methods for processing digital video content that utilize artificial intelligence (AI) and object recognition algorithms to detect objects within video streams and apply augmented reality overlays based on object orientation and positioning relative to imaging devices. The present technology improves upon certain limitations in augmented reality systems by providing enhanced object recognition accuracy and real-time processing capabilities that can be specifically tailored for detecting drinkware within digital video content. To militate against visual disconnects between objects and superimposed augmented reality (AR) images when such objects change orientation, the present technology determines precise orientation and positioning of drinkware objects to maintain realistic visual integration. The system applies contextually relevant augmented reality overlays that can be seamlessly integrated based on optimal viewing angles and surface geometry, addressing challenges that cause cartoonish or unrealistic appearances in certain augmented reality applications. The superimposed image maintains professional aesthetic quality during videoconferencing and digital content applications while overcoming object recognition limitations in varying lighting conditions, occlusion, and complex environments.

The present technology also finds applicability in various contexts, including video communication platforms, such as video-based applications, live streaming services, social media applications, or broadcast system platforms, and other video session scenarios. The present technology contemplates the use of various applications and can be implemented and described herein through a system that provides enhanced augmented reality functionality for detecting drinkware objects and overlaying contextual content during digital video sessions. It should be understood that the present technology is not limited to videoconferencing applications and can also be used in various electronic devices, prerecorded content, live streams, broadcasts, and displays that incorporate AR. The present description of videoconferencing implementations provides an illustrative example of the present technology that should be considered non-limiting and which is used solely as a model in describing the present technology.

In certain embodiments, a system for displaying an augmented-reality object on a drinkware within a digital video content for a user is provided. The system can include an imaging device, a processor, and a memory in communication with the processor. The memory can include a detection module, an orientation module, a rendering module, a dashboard, a gamification module, a compliance module, and a database. The imaging device can capture the digital video content and provide the digital video content to the detection module. The detection module can receive the digital video content from the imaging device, identify a visual object within the digital video content as the drinkware, and identify a surface of the drinkware. The orientation module can analyze the drinkware to determine when the drinkware is tilted to an image-generating position where the surface of the drinkware is viewable in the digital video content. The rendering module can overlay an augmented-reality object onto the surface of the drinkware when an orientation of the drinkware meets a predetermined angular threshold relative to the imaging device.

In certain embodiments, a non-transitory computer-readable storage medium is provided, operable to store processor instructions for displaying an augmented-reality object on a drinkware within a digital video content for a user. When the processor instructions are executed by a processor, the processor instructions can cause the processor to capture the digital video content via an imaging device and provide the digital video content to a detection module. The processor instructions can cause the processor to identify a visual object within the digital video content as the drinkware. The processor instructions can cause the processor to identify the surface of the drinkware via a detection module. The processor instructions can cause the processor to analyze the drinkware via an orientation module to determine when the drinkware is tilted to an image-generating position where the surface of the drinkware is viewable in the digital video content. The processor instructions can cause the processor to overlay an augmented-reality object onto the surface of the drinkware via a rendering module when an orientation of the drinkware meets a predetermined angular threshold relative to the imaging device.

In certain embodiments, a method for displaying an augmented-reality object on a drinkware within a digital video content for a user is provided. The method can include a step of providing the imaging device, the processor, and the memory in communication with the processor, where the memory includes the detection module, the orientation module, the rendering module, the dashboard, the gamification module, the compliance module, and the database. The method can include a step of capturing the digital video content via the imaging device and providing the digital video content to the detection module. The method can include a step of identifying a visual object within the digital video content as the drinkware and identifying the surface of the drinkware via the detection module. The method can include a step of analyzing the drinkware via the orientation module to determine when the drinkware is tilted to an image-generating position where the surface is viewable in the digital video content. The method can include a step of overlaying an augmented-reality object onto the surface of the drinkware via the rendering module when an orientation of the drinkware meets a predetermined angular threshold relative to the imaging device.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagram illustrating aspects of a system for displaying an augmented-reality object on a drinkware within a digital video content for a user;

FIG. 2 is a block diagram illustrating further aspects of a system for displaying an augmented-reality object on a drinkware within a digital video content for a user;

FIG. 3 is a block diagram illustrating additional aspects of a system for displaying an augmented-reality object on a drinkware within a digital video content for a user;

FIGS. 4-7 illustrate portions of a video session where an augmented-reality object is displayed on a drinkware;

FIGS. 8A, 8B, and 8C illustrate a video session where an augmented-reality object is visibly displayed on a drinkware when tilted to an image-generating position (FIGS. 8A & 8B), and the augmented-reality object is not visibly displayed on the drinkware when the drinkware is in an upright orientation (FIG. 8A);

FIG. 9 illustrates a video session where multiple augmented-reality objects are displayed on multiple drinkware;

FIG. 10 illustrates an augmented-reality object displayed on a transparent drinkware;

FIG. 11 illustrates an augmented-reality object displayed on a drinkware that is opaque or that appears dark in color;

FIG. 12 illustrates a video session where a toolbar and overlay options are displayed during a video session;

FIGS. 13 and 14 illustrate orientations of a drinkware where an augmented-reality object is visibly displayed on a drinkware when tilted to an image-generating position (FIG. 14), and the augmented-reality object is not visibly displayed on the drinkware when the drinkware is in an upright orientation (FIG. 13);

FIGS. 15A and 15B illustrate a video session where a toolbar and overlay options are hidden during a video session;

FIG. 16 illustrates a recap screen at the end of a video session;

FIGS. 17A and 17B provide a flowchart illustrating an embodiment of a method for displaying an augmented-reality object on a drinkware within a digital video content for a user;

FIG. 18 provides a flowchart extending from FIGS. 17A and 17B and further illustrates a method for displaying an augmented-reality object on a drinkware within a digital video content for a user;

FIG. 19 provides a flowchart extending from FIGS. 17A and 17B and further illustrates a method for displaying an augmented-reality object on a drinkware within a digital video content for a user;

FIG. 20 provides a flowchart extending from FIGS. 17A and 17B and further illustrates a method for displaying an augmented-reality object on a drinkware within a digital video content for a user;

FIG. 21 provides a flowchart extending from FIGS. 17A and 17B and further illustrates a method for displaying an augmented-reality object on a drinkware within a digital video content for a user;

FIG. 22 provides a flowchart extending from FIGS. 17A and 17B and further illustrates a method for displaying an augmented-reality object on a drinkware within a digital video content for a user;

FIGS. 23A, 23B, and 23C provide a flowchart illustrating an embodiment of a method for operating a system for displaying an augmented-reality object on a drinkware;

FIG. 24 provides a flowchart extending from FIGS. 23A, 23B, and 23C and further illustrates a method for operating a system for displaying an augmented-reality object on a drinkware;

FIGS. 25A and 25B provide a flowchart illustrating an embodiment of a method for operating a mobile application for displaying an augmented-reality object on a drinkware; and

FIG. 26 provides a flowchart illustrating an embodiment of a method for operating a toolbar and overlay options during a video session.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as can be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items can be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that can arise from ordinary methods of measuring or using such parameters.

Although the open-ended term “comprising,” as a synonym of non-restrictive terms such as including, containing, or having, is used herein to describe and claim embodiments of the present technology, embodiments can alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that can be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter can define endpoints for a range of values that can be claimed for the parameter. For example, if Parameter X is exemplified herein to have value A and also exemplified to have value Z, it is envisioned that Parameter X can have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X can have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it can be directly on, engaged, connected or coupled to the other element or layer, or intervening elements or layers can be present. In contrast, when an element is referred to as being “directly on,” “directly engaged to,” “directly connected to” or “directly coupled to” another element or layer, there can be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed contents.

Although the terms first, second, third, etc. can be used herein to describe various elements, components, regions, layers and/or sections, these elements, components, regions, layers and/or sections should not be limited by these terms. These terms can be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, can be used herein for ease of description to describe one element or feature's relationship to another element(s) or feature(s) as illustrated in the figures. Spatially relative terms can be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

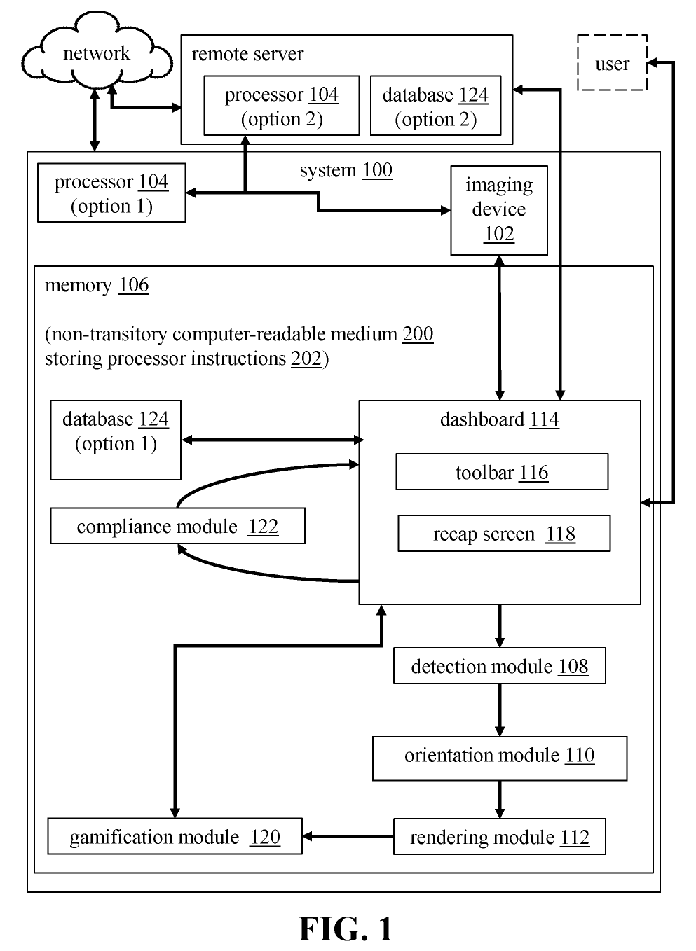

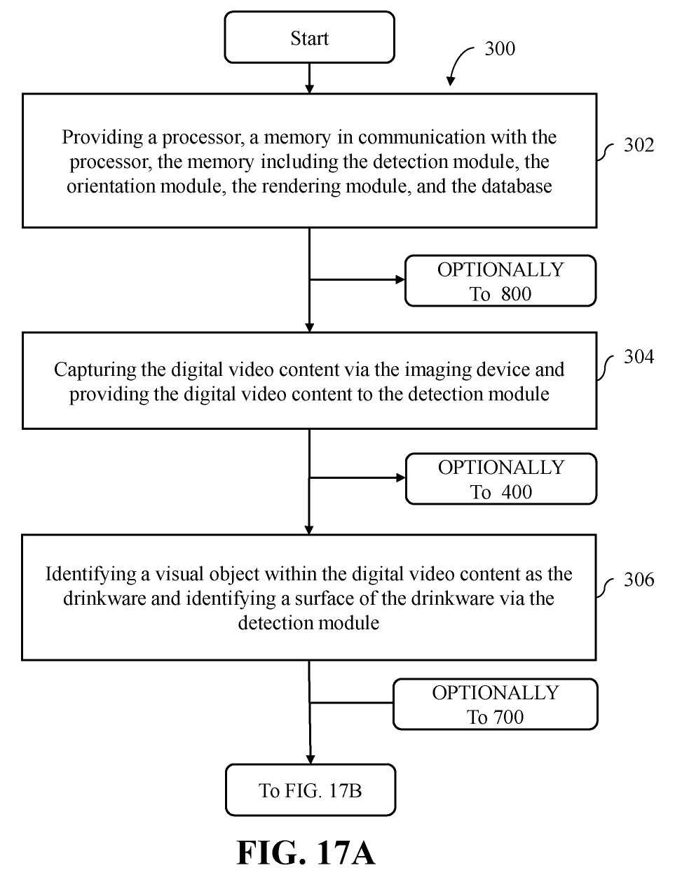

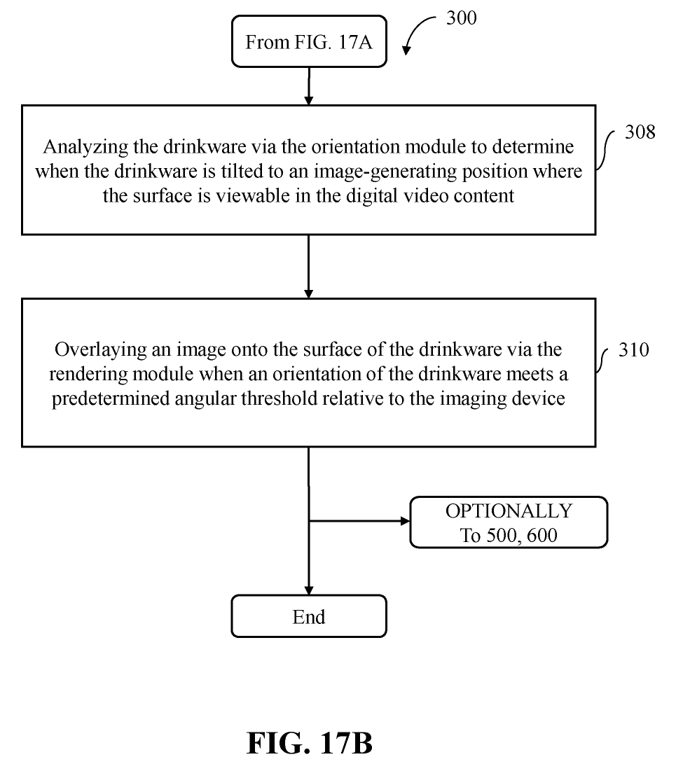

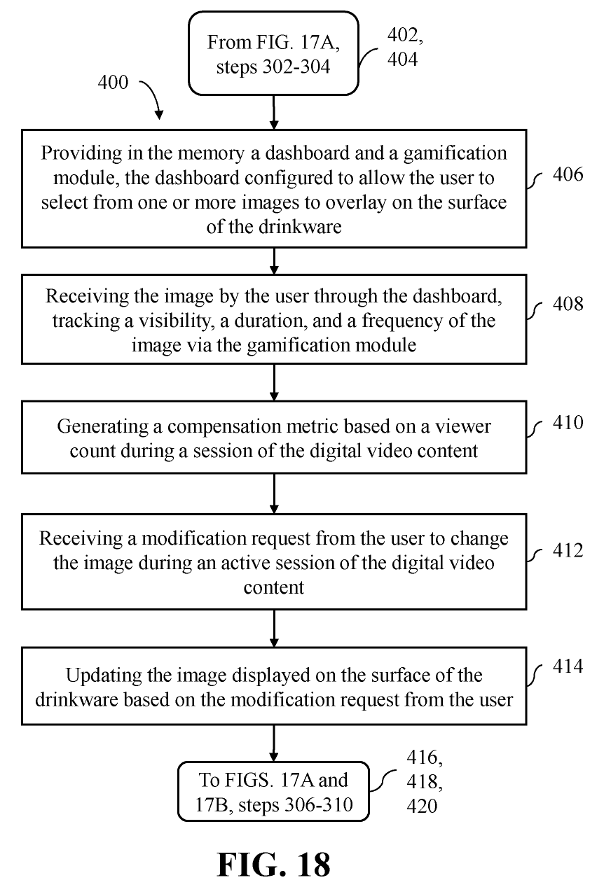

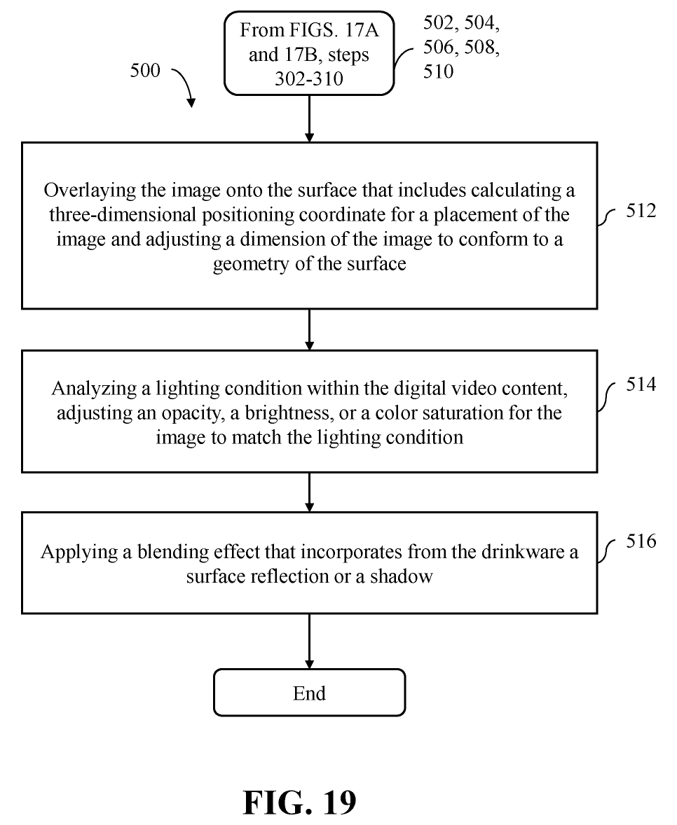

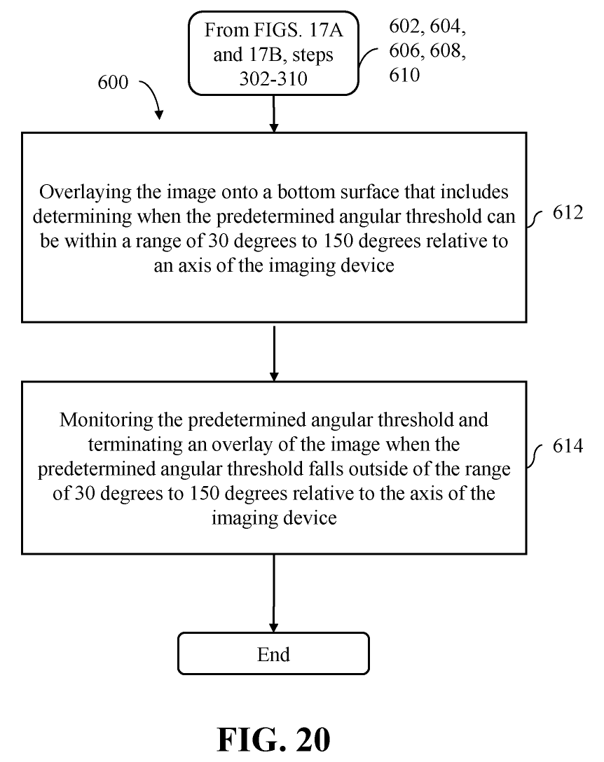

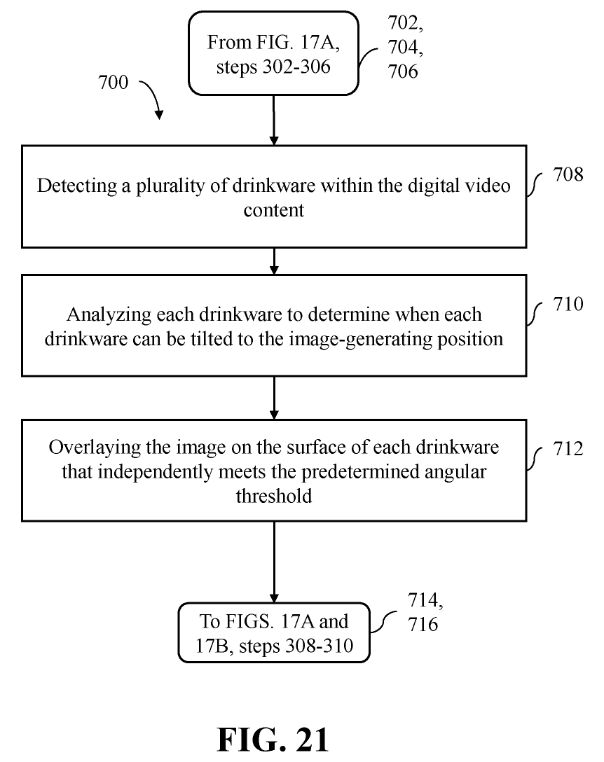

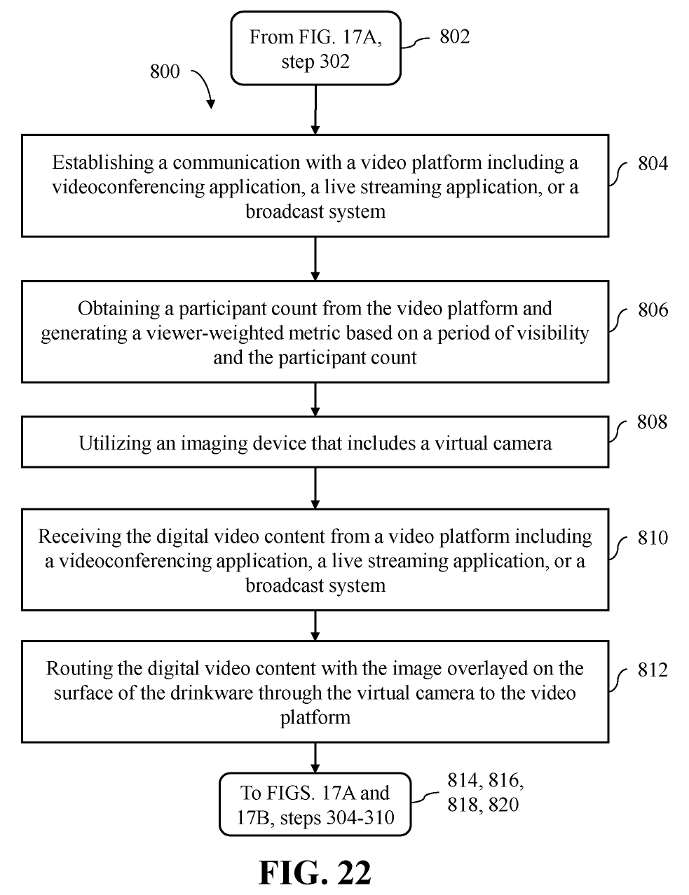

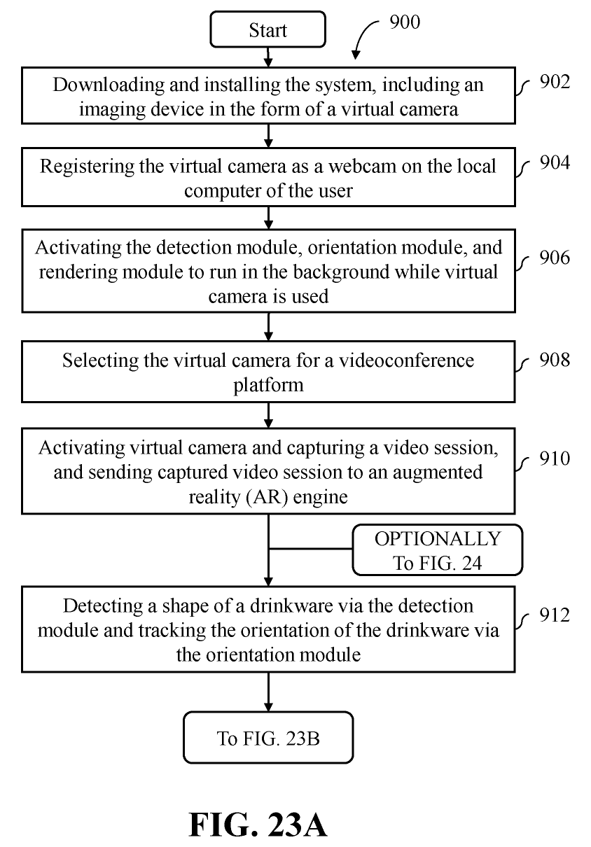

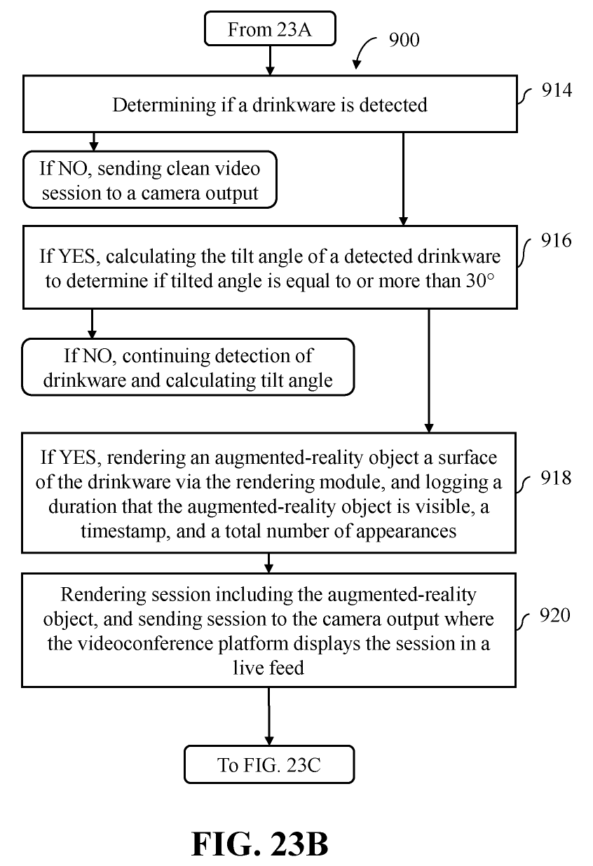

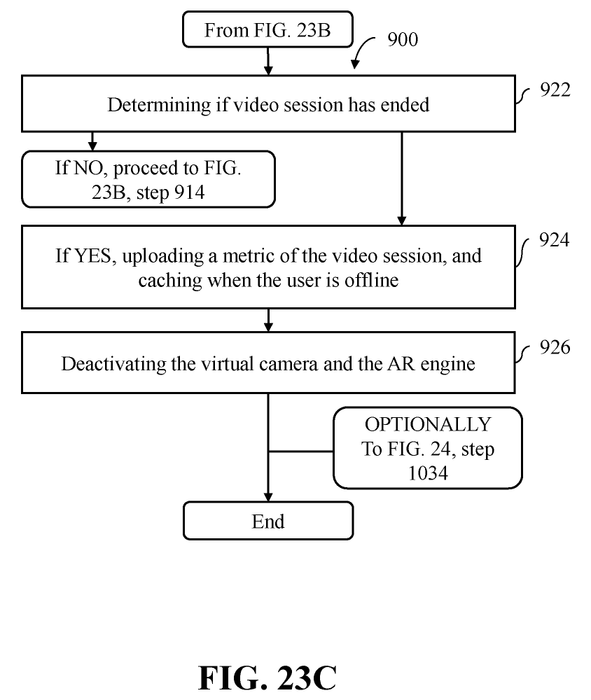

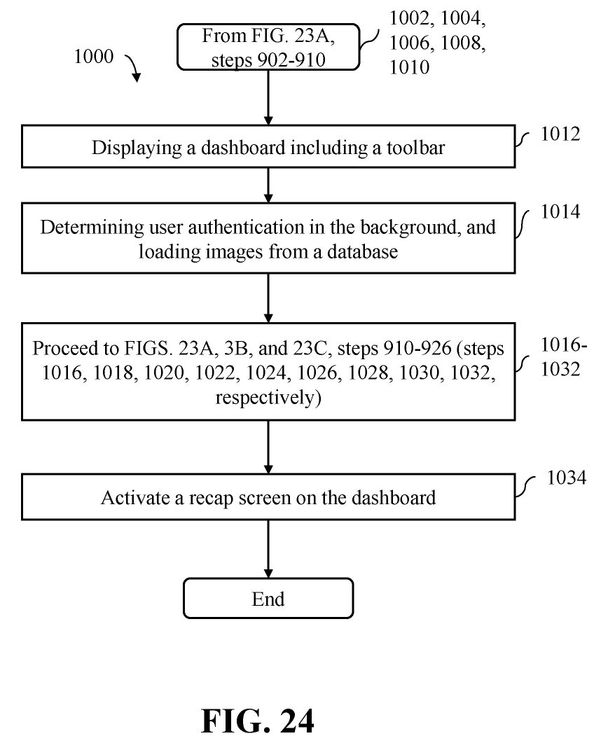

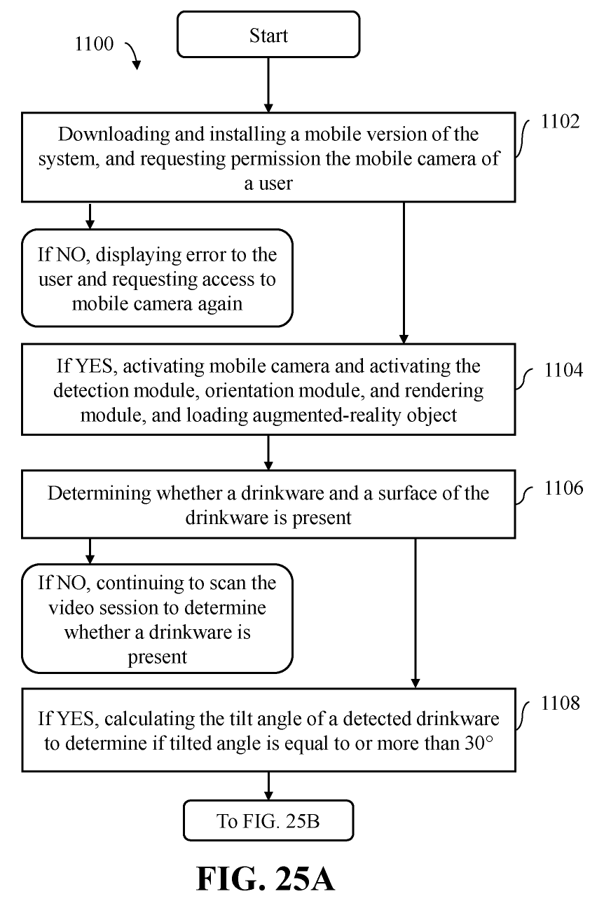

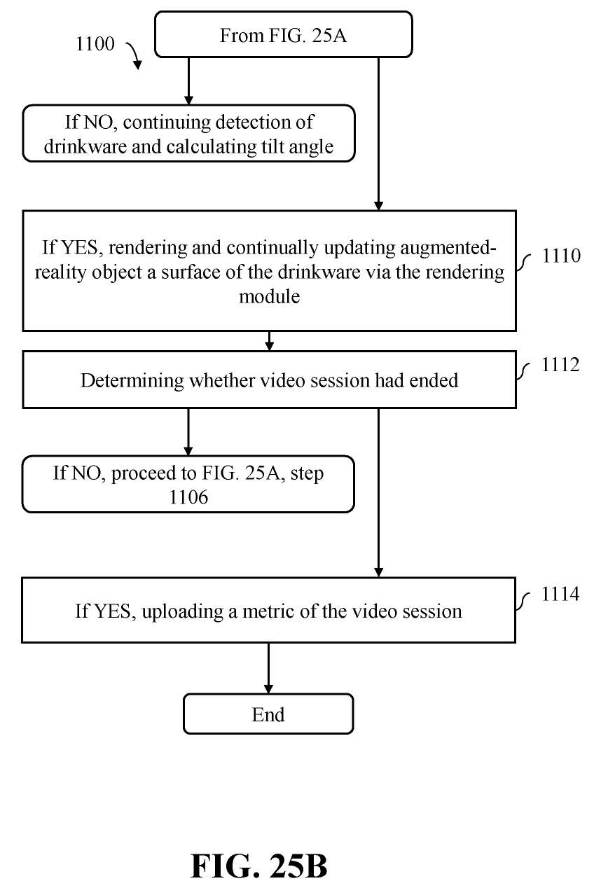

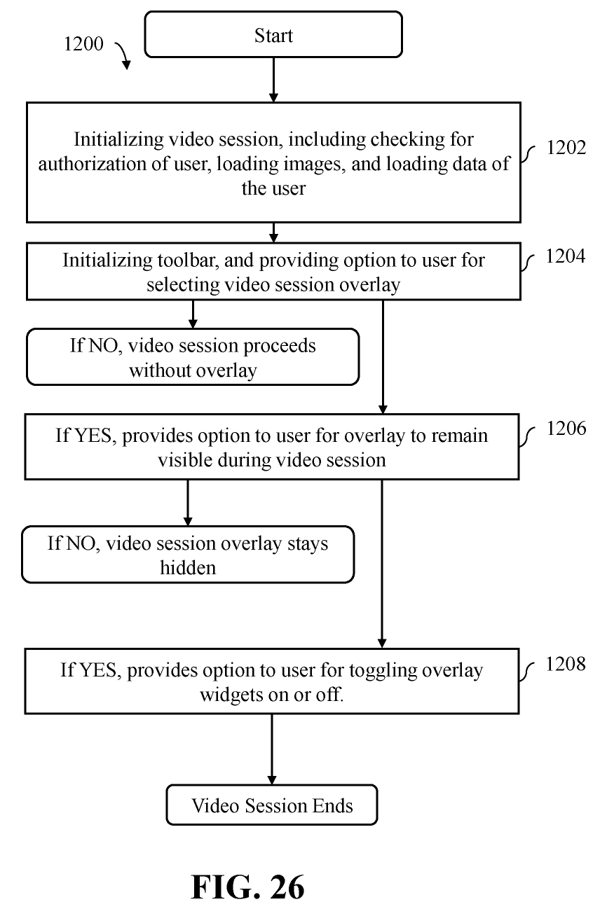

The present technology provides a system 100 and non-transitory computer-readable storage medium 200 for displaying an augmented-reality object on a drinkware within a digital video content for a user, aspects of which are shown generally in accompanying FIGS. 1-16. A method 300 for displaying an augmented-reality object on a drinkware within a digital video content is also provided, aspects of which are shown in FIGS. 17A and 17B. A method 400 for displaying an augmented-reality object on a drinkware within a digital video content is also provided, aspects of which are shown in FIG. 18. Another method 500 for displaying an augmented-reality object on a drinkware within a digital video content is provided, aspects of which are shown in FIG. 19. Another method 600 for displaying an augmented-reality object on a drinkware within a digital video content is provided, aspects of which are shown in FIG. 20. Yet another method 800 for displaying an augmented-reality object on a drinkware within a digital video content is also provided, aspects of which are shown in FIG. 21. And yet another method 900 for displaying an augmented-reality object on a drinkware within a digital video content is also provided, aspects of which are shown in FIG. 22. A method 900 for operating a system for displaying an augmented-reality object on a drinkware is also provided, aspects of which are shown in FIGS. 23A-23C. Another method 1000 for operating a system for displaying an augmented-reality object on a drinkware is also provided, aspects of which are shown in FIG. 24. A method 1100 for operating a mobile application for displaying an augmented-reality object on a drinkware is also provided, aspects of which are shown in FIGS. 25A-25B. A method 1200 for operating a toolbar and overlay options during a video session is also provided, aspects of which are shown in FIG. 26.

The system 100, and methods 300, 400, 500, 600, 700, 800, 900, 1000, 1100, and 1200 allow for the detection of drinkware within digital video content and augmented reality objects to be superimposed on the drinkware for dynamic presentation of content such as logos or product information during video sessions. As shown in FIGS. 1-16, the system 100 can include a processor 104 and a memory 106 in communication with the processor 104. The memory 106 can include a detection module 108, an orientation module 110, a rendering module 112, a dashboard 114 including a toolbar 116 and a recap screen 118, a gamification module 120, a compliance module 122, and a database 124. The system 100 can utilize the imaging device 102 to provide digital video content 126 to the detection module 108 which can identify a drinkware 128. The orientation module 110 can analyze when the drinkware 128 is tilted to superimpose an augmented-reality object 130 on the surface 132 the drinkware 128 when the drinkware 128 is in an image-generating position 134, and the rendering module 112 overlays an augmented-reality object 130 onto the surface 132 of the drinkware 128 when tilted relative to the imaging device 102, with additional support from a gamification module 120, dashboard 114, and database 124 for enhanced user engagement across various platforms.

The system 100 can be implemented across various platforms including desktop applications, browser extensions, and mobile applications to provide augmented reality functionality within digital video content 126 environments. The system 100 can operate in conjunction with different types of conference applications, social media video applications, and business management platforms to enhance user interaction during video sessions 136. For example, the system 100 can be downloaded as a stand-alone application, installed as a plugin associated with an existing videoconference application, cloud-based, or hybrid approaches involving server and local implementations. The platform-agnostic nature of the system 100 allows for deployment across multiple operating environments while maintaining consistent functionality and user experience. The system 100 can be integrated with a videoconferencing application 188 such as those identified by the tradenames Microsoft Teams®, Zoom®, GoToMeeting®, Google Meet®, and similar platforms to provide real-time augmented reality capabilities during video sessions 136. Such integration can be established through application programming interfaces (APIs), extensions, or specific versions of such platforms on a mobile application or installed on a local computer. Although the system 100 can be compatible with various types of videoconferencing platforms, it should be appreciated that the system 100 can also be used with other computer-based solutions involving video capture of a participant by a camera of a computer and a sharing of the video captured with another participant on a video display, for example, a computer monitor, screen, or projection, and can be utilized with social media, business management, employment, commercial, and other enterprise applications, desktop computer, laptop computers, tablets, and mobile devices such as smartphones, and other electronic devices as non-limiting examples.

The system 100 can allow a user to directly utilize the system 100 or experience the augmented reality (AR) features in coordination with external platforms. A user can include an organizer of a video session 136, a participant of a video session 136, other participants that either include AR rendering on a drinkware 128 or view other users doing so, a viewer that is not a participant but watching the video session 136, a sponsor related to an augmented-reality object 130 being used in the video session 136, or an audience member of the video session 136 that can have viewing access.

The imaging device 102 can comprise various forms of video capture equipment including various types of cameras, digital cameras, or virtual camera 127 implementations that can capture digital video content 126 in real-time, e.g., the actual time during which a process or event occurs. In other words, the imaging device 102 can include implementations utilizing digital twin technology, e.g., virtual replica of a physical object, system, or environment that is continuously updated with real-time data from sensors, or that enable advanced video processing capabilities while maintaining compatibility with standard video input requirements. The imaging device 102 can capture high-quality digital video content 126 at various resolutions and frame rates suitable for real-time processing and analysis. The captured digital video content 126 from the imaging device 102 can be utilized to subsequent processing components within the system 100 for object detection and augmented reality operations.

The imaging device 102 can include integration with production software, e.g., Open Broadcast Software® (OBS), that can provide enhanced video processing and virtual camera 127 functionality for augmented reality operations. For example, the imaging device 102 can utilize OBS as a control framework where embedded OBS scripts can detect camera selection events and automatically launch background processing components such as Unity rendering engines. The imaging device 102 can establish frame transport protocols, for example, that enable real-time communication between augmented reality processing modules and OBS virtual camera 127 output, or route processed video content through an OBS broadcasting pipeline, where composited video streams containing augmented-reality objects 130 can be transmitted through the virtual camera 127 interface to external platforms and applications. The imaging device 102 can, for example, incorporate OBS architecture to maintain compatibility with standard video input requirements and seamlessly integrate with the system 100. It should be understood that the imaging device 102 can implement virtual camera 127 functionality that routes a processed video session 136 through standard camera interfaces, enabling compatibility with existing video communication software without requiring platform-specific integrations. Alternatively, the imaging device 102 can include the option to select a prerecorded stream for rendering an augmented-reality object 130 onto a detected drinkware 128.

The processor 104 within the system 100 can comprise single or multiple processing units capable of executing complex computational tasks required for real-time video analysis and augmented reality rendering. The processor 104 can include specialized processing units such as graphics processing units, central processing units, or dedicated artificial intelligence (AI) processing hardware optimized for computer vision tasks. The processing capabilities of processor 104 can be distributed across multiple cores or processing elements to handle concurrent operations including video analysis, object recognition, and rendering tasks. The processor 104 can be selected based on the computational requirements of the specific platform implementation and the desired performance characteristics of the system 100.

The processor 104 can execute various modules and components for detecting drinkware 128 within digital video content 126 and overlaying or superimposing an augmented reality object onto a surface 132 of the drinkware 128. The processor 104 can operate in conjunction with the database 124 or other storage infrastructure services now available or later developed to provide data storage and retrieval capabilities, user authentication and video session 136 management functionality, tracking of a gamification metric 176, and content management services for augmented reality detection. The processor 104 can be located locally on the system 100, labeled as the processor 104 option 1 in FIG. 1, or a remote server accessed via a network, labeled as the processor 104 option 2 in FIG. 1. One skilled in the art will also appreciate that the processor 104 can include one or more processors and can process information and execute the various instructions or operations, as described herein. For example, the processor 104 can include processing circuitry such as a central processing unit (CPU), a microprocessor, a microcontroller, a system-on-a-chip, a digital signal processor (DSPs), field-programmable gate arrays (FPGAs), application-specific integrated circuits (ASICs), and/or a processor based on a multi-core processor architecture. The processor 104 can include one or more processors such as a single processor or multiple processors in a single processing unit, e.g., a central processing unit, or multiple processing units, e.g., a central processing unit and a graphics processing unit, or a central processing unit and a memory 106 manager. The processor 104 can include multiple processors where one processor is capable of executing one or more of the elements described in this disclosure, and a subsequent processor or processors can execute other elements as described herein, capable of executing all elements only in combination. The processor 104 can include one or more processors where at least one processor is remote from the at least one local server.

The memory 106 can be implemented as various forms of data storage including volatile memory, non-volatile memory, or combinations thereof to support the operational requirements of the system 100. The memory 106 can include multiple distinct modules that provide specialized functionality for different aspects of the augmented reality processing pipeline. The memory 106 can be organized to facilitate efficient data access patterns required for real-time video processing and object recognition operations. The memory 106 can store program instructions, temporary data structures, and configuration parameters necessary for the operation of the various functional modules within the system 100. The memory 106 can be in communication with the processor 104 and can include both volatile and non-volatile memory components. The memory 106 can store program instructions, operating software, and applications required for system 100. The memory 106 can include additional modules that work together to provide comprehensive augmented reality functionality for detecting drinkware 128 and for rendering a contextually relevant augmented-reality object 130 during a video session 136. The memory 106 can store or otherwise include a database 124. The memory 106 can include one or more memories, can include a memory subsystem, can include a memory of any type suitable to the system 100, and can be implemented using any suitable volatile or nonvolatile data storage technology such as a semiconductor-based memory device, a magnetic memory device, an optical memory, a fixed memory, and/or a removable memory. For example, the memory 106 can include any combination of random-access memory (RAM), read only memory (ROM), static storage such as a magnetic or optical disk, a hard disk drive (HDD), or any other type of non-transitory machine or computer readable media.

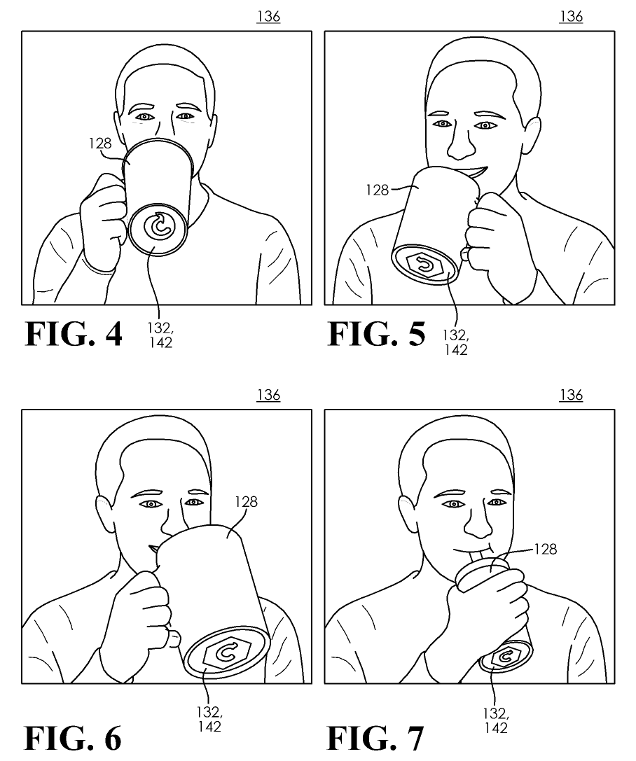

With reference to FIGS. 1-3, the detection module 108 can receive digital video content 126 from the imaging device 102 and perform object recognition operations on digital video content 126. The detection module 108 can utilize machine learning algorithms and computer vision techniques to identify visual objects 138 within the digital video content 126 and classify them according to predefined categories including various types of drinkware 128. The detection module 108 can be capable of identifying multiple objects simultaneously within a single video frame and can distinguish between different types of drinkware 128, for example, cups, mugs, glasses, tumblers, and other beverage containers. The detection module 108 can also incorporate hand detection capabilities to better understand the context and positioning of identified drinkware 128 within the video content. The detection module 108 can identify specific surfaces 132 of detected drinkware 128, for example, focusing on a bottom surface 142 of the drinkware 128. For example, the detection module 108 can detect a boundary of the surface 132, such as s circumference of the bottom surface 142. When the detection module 108 detects a shape, e.g., a circle defining a boundary of a bottom surface 142 when the drinkware 128 is tilted to a position that placed it fully in view of the camera, or an ellipse defining a boundary of the bottom surface 142 when the bottom surface 142 is not yet tilted to a position that places it fully in view of the camera. The detection module 108 can, for example, identify a size or a surface 132 area associated with an interior of the shape boundary determined by the application, as shown in FIGS. 4-7, comparing the surface 132 area to a viewing area of the video being captured and displayed.

The orientation module 110 can determine when the drinkware 128 has been tilted to positions suitable for overlaying or superimposing an augmented-reality object 130 onto the drinkware 128. For example, the orientation module 110 can calculate a rotation, a tilt, a viewing angle relative to the camera, or a degree of rotation that includes an image-generating position 134 or a substantially upright position including a position that is substantially orthogonal, or within an angle, relative to an axis 144 extending from the camera or associated with a line of sight of the camera. For example, image-generating position 134 can be within an angle relative to an axis 144 that can include the drinkware 128 rotating along a Z axis 144, an X axis 144, or a Y axis 144, as shown in FIGS. 13 and 14, where the augmented-reality object 130 can dynamically mirror the shape of the drinkware 128 in real time. One skilled in the art can select various axis 144 points in which to determine an image-generating position 134, as desired. The orientation module 110 can analyze the three-dimensional positioning of drinkware 128 across multiple axes 144 to accurately assess an image-generating position 134, e.g., an optimal viewing angles for augmented reality content. In other words, the orientation module 110 can assess the point in which the surface 132 of the drinkware 128 is optimally visible to a user or to another participant of the video session 136.

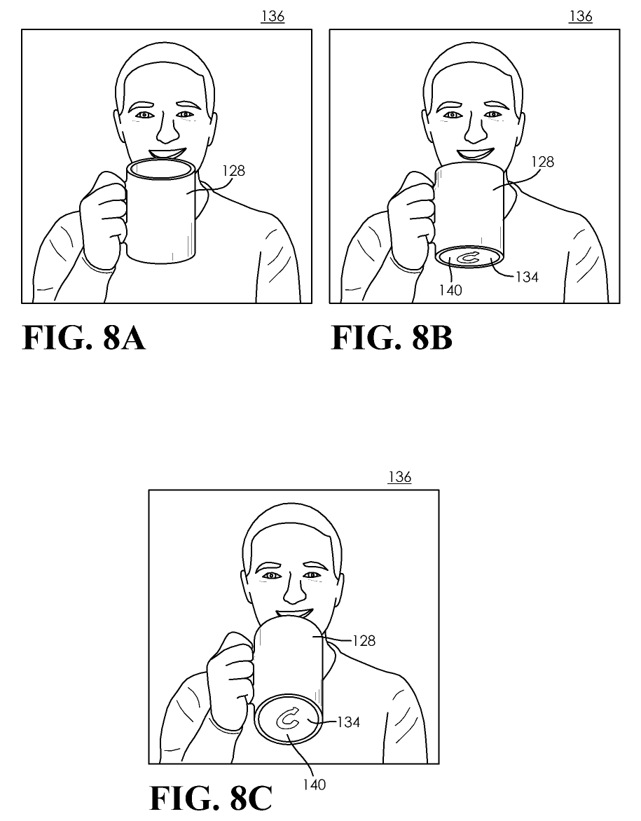

The orientation module 110 can detect a range 166 of the orientation 149 of a drinkware 128 to establish a degree-based threshold for determining when the drinkware 128 is positioned appropriately for generating an augmented-reality object 130, for example, as shown in FIGS. 8A-8C. For example, the orientation module 110 can determine when an augmented-reality object 130 should be dynamically adjusted in terms of scaling, stretching, or geometric transformation to properly fit the surface 132 geometry as the drinkware 128 changes position. In other words, the orientation module 110 can calculate the degree of rotation when the drinkware 128 is in a position that places a surface 132 within view when the augmented-reality object 130 is superimposed on the surface 132. The orientation module 110 can calculate a three- dimensional positioning coordinate 146 for a placement of the image 140 and adjust a dimension 148 of the image 140 to conform to a geometry of the surface 132.

The orientation module 110 can implement a predetermined angular threshold 164, for example, a range 166 of 30 degrees to 150 degrees relative to an axis 144 of the imaging device 102 to optimize image 140 visibility 184 and aesthetic presentation. The orientation module 110 can continuously monitor the orientation 149 of the drinkware 128 and automatically terminate the image 140 when the orientation 149 falls outside the specified threshold range 166. The image-generating position 134 can be determined when a sufficient portion of the drinkware 128 surface 132 becomes viewable within the digital video content 126, ensuring that images 140 have adequate space for clear presentation. The orientation module 110 can apply hysteresis algorithms to militate against rapid activation and deactivation of the image 140 when a drinkware 128 is positioned near the threshold boundaries. It should be understood that the image-generating position 134 can be one that is substantially orthogonal, or within a predetermined angle, relative to an axis 144 extending from the camera that is capturing the video or providing the video for viewing, and which is associated with a line of sight. The image-generating position 134 can be selected to be a position in which a portion of the surface 132 is exposed to the camera.

The orientation module 110 can incorporate handle detection capabilities that enable analysis of drinkware 128 with handle configurations to determine rotational orientation 149 patterns that differ from handleless drinkware 128. The orientation module 110 can analyze user hand positioning and finger placement patterns relative to detected handles to assess three-dimensional rotational movement along multiple axes, for example, along Z-axis 144 and X-axis 144 positioning coordinates. For example, the orientation module 110 can calculate rotational adjustments when drinkware 128 are twisted inward or outward during upright positioning, or rotated left or right when tilted, ensuring that augmented-reality object 130 placement maintains realistic visual alignment with the drinkware 128 surface 132 geometry. It should be appreciated that the orientation module 110 can utilize hand and finger positioning data as indicators for determining cylindrical rotation of the drinkware 128 when the presence of a hand obscures the orientation 149 of the drinkware 128 surface 132, for example, as shown in FIG. 7. For example, the orientation module 110 can correlate handle detection results with hand positioning analysis to generate enhanced rotational tracking algorithms that provide improved accuracy for augmented-reality object 130 orientation 149 calculations when drinkware 128 exhibit three-dimensional movement patterns during video sessions 136. It should also be appreciated that the orientation module 110 can detect the orientation 149 of the drinkware 128 regardless of whether a handle is present and can operate agnostically with regard to the overall shape or hand placement on the drinkware 128.

The augmented-reality object 130 can include an image 140, e.g., an interactive image 140 that allows a user to click on the image 140 to access links, additional content, audio content, visual content, or content tracking. The image 140 can be a promotional image 140 such as a trade name, logo, or Quick Response (QR) code used for advertising, an infographic image 140 containing information text to be read by the user, or other images 140 such as pictures, photographs, advertisement materials for entity information, commercial or employment information, animated images 140 in graphics interchange format (GIFs), audio visual (AV) images 140, and images 140 that change responsive to the orientation 149 of the surface 132 of the drinkware 128, as non-limiting examples. For example, the augmented-reality object 130 can include projections or videos such as cartoons, avatars, scenery, recordings that can continuously play while visible on the surface 132 of the drinkware 128 or commence or cease motion upon the orientation 149 of the drinkware 128 relative to the camera or the view of the user, other participants, or audience. The augmented-reality object 130 can include unique numbering for reuse and to militate against creating duplicate augmented-reality objects 130 stored in the database 124.

The rendering module 112 can handle the overlaying of images 140 onto identified drinkware 128 surfaces 132 when specific orientation 149 criteria are satisfied. For example, the rendering module 112 can utilize advanced augmented reality engines suitable for both desktop and mobile application environments to create a realistic and seamless image 140. The rendering module 112 can dynamically adjust image 140 properties including scaling, stretching, and geometric transformation to ensure proper fit and alignment with the detected drinkware 128 surface 132 as the object moves or changes orientation 149. In other words, the rendering module 112 can adjust the image 140 to match the drinkware 128 orientation 149, which, for example, can be a predetermined number of times per second. It should be appreciated that a high adjustment rate per second can allow for the rendering module 112 to continue optimizing the vector characteristics of the image 140 and appear realistic as though the drinkware 128 includes the image 140 without augmentation.

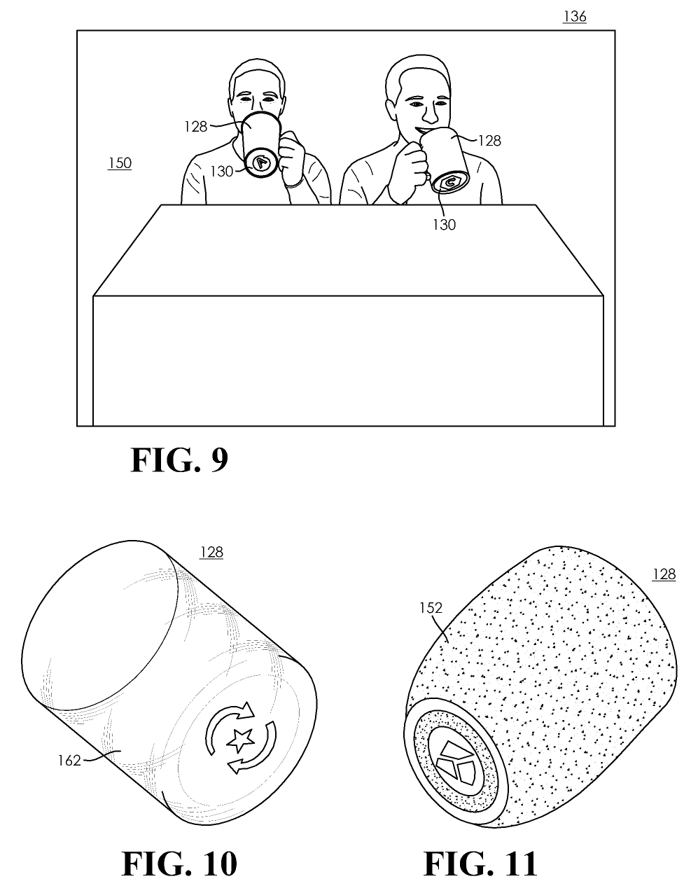

As shown in FIG. 9, the rendering module 112 can support multiple concurrent drinkware 128 within a single video frame, for example, FIG. 9, allowing the rendering module 112 to apply images 140 to each qualifying object independently. When multiple drinkware 128 are detected simultaneously, the detection module 108 can prioritize objects based on factors such as size, proximity to the camera, or clarity of surface 132 visibility 184. For example, multiple drinkware 128 can be tracked separately, applying individual angular threshold 164 assessments to each drinkware 128. The rendering module 112 can apply different images 140 to different drinkware 128 within the same video frame, enabling diverse advertising or informational content presentation during a single video session 136.

The rendering module 112 can incorporate color adjustment, brightness 152 modification, and transparency control capabilities to ensure that overlaid images 140 blend naturally with the underlying video content. The rendering module 112 can apply blending effects 156 that incorporate surface reflections 158, shadows 160, and other visual elements from the drinkware 128 to create more realistic augmented reality presentations. For example, the rendering module 112 can analyze ambient lighting conditions 150 within the digital video content 126 and automatically adjust image 140 brightness 152, contrast, and color saturation 154 to match the environmental characteristics. The rendering module 112 can apply dynamic blending effects 156 that incorporate surface reflections 158, shadows 160, and specular highlights from the drinkware 128 to create more convincing augmented reality presentations. The rendering module 112 can adjust image 140 opacity 162 and transparency levels based on detected lighting conditions 150 to maintain visual coherence between the augmented-reality object 130 and the underlying video imagery.

The color, brightness 152, transparency, and blending effects 156 of the rendering module 112 can be determined by, for example, environmental and surface 132 characteristics to determine optimal presentation based on contrast optimization algorithms. As shown in FIG. 10, the rendering module 112 can detect color properties and brightness 152 levels of the identified drinkware 128 surface 132 in conjunction with ambient lighting conditions 150 within the digital video content 126 captured by the imaging device 102. The rendering module 112 can access multiple image 140 variants stored in the database 124, including light and dark versions of augmented-reality objects 130, and can automatically select the variant that provides optimal visual contrast against the detected surface 132 characteristics. The rendering module 112 can evaluate multiple environmental factors including cup color, cup brightness 152, atmospheric lighting around the user, background lighting conditions 150, and overall scene illumination to determine the most appropriate image 140 variant for display. For example, the rendering module 112 can evaluate the transparency of a drinkware 128 made of glass, as shown in FIG. 10, and render an augmented-reality object 130 that includes the same transparent characteristics. The rendering module 112 can dynamically adjust color properties of augmented-reality objects 130 when multiple image 140 variants are unavailable, modifying brightness 152, contrast, and color saturation 154 parameters to ensure optimal visibility 184 and professional appearance against varying surface 132 and lighting conditions 150 detected during video sessions 136.

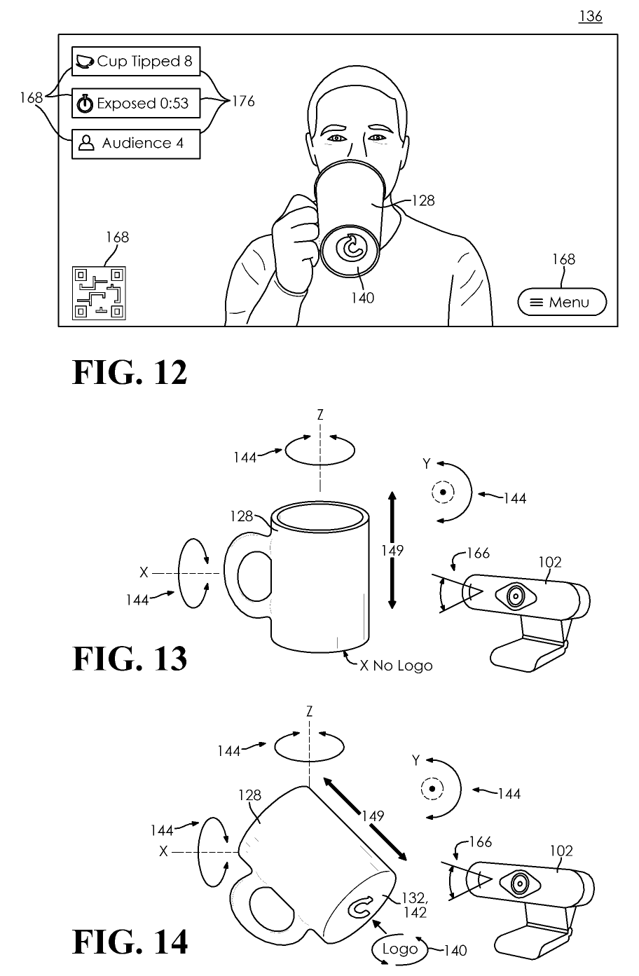

The dashboard 114 can provide user interface capabilities for managing various aspects of the augmented reality experience. The dashboard 114 can include interactive elements that allow users to configure system 100 settings, select images 140, and monitor system 100 performance during video sessions 136. The dashboard 114 can incorporate real-time feedback mechanisms that provide users with information about object detection status, orientation 149 analysis results, and rendering activities. The dashboard 114 can be implemented as an overlay 168 interface, for example, as shown in FIG. 12, that remains accessible during video sessions 136 without interfering with the primary video content or the augmented reality rendering operations. Alternatively, the dashboard 114 can include, for example, a cloud-based user portal having a graphical user interface (GUI) that permits for an uploading and/or creation by the user of the predetermined augmented-reality object 130, e.g., an image 140, and also the identification by the user of the parameters, e.g., size, area, and orientation 149 of the bottom surface 142 of the drinkware 128, that cause the system 100 to generate and superimpose the image 140 over the bottom surface 142 on the video display.

The toolbar 116 can provide streamlined access to frequently used functions and settings within the system 100. The toolbar 116 can include image 140 upload and selection capabilities that allow users to quickly choose from available images 140 or upload new content for use in connection with an augmented reality overlay 168. The toolbar 116 can incorporate widget-based interface elements that can be customized and arranged according to user preferences and operational requirements. For example, the toolbar 116 can provide immediate access to toggle functions that enable or disable various aspects of the augmented reality functionality during active video sessions 136. The toolbar 116 can be positioned and sized to provide convenient access while minimizing interference with the underlying video content and user experience. For example, the toolbar 116 can be provided to the user with overlay 168 options such as a persistent heads-up display (HUD) that remains visible during the video session 136, allowing the user to authenticate, select, or change the augmented-reality object 130 such as an image 140, or change user preferences. The user can choose from options such as displaying an image 140 or ceasing to display the image 140 mid-video session 136.

The toolbar 116 can incorporate dynamic switching between different augmented-reality objects 130 during active video sessions 136 without interrupting the ongoing video communication. For example, the toolbar 116 can provide interface elements that allow users to select from multiple pre-loaded logo options stored in the database 124, facilitating seamless transitions between different promotional content based on changing session requirements or participant configurations. The toolbar 116 can, for example, enable users to switch between different sponsor logos, brand identifications, or an informational overlay 168 when session participants change, such as transitioning from one corporate the logo of a sponsor to another sponsor's logo when different speakers or participants join the video session 136. The toolbar 116 can communicate switching requests to the rendering module 112 to ensure that transitions appear smooth and professional to all video session 136 participants while maintaining proper orientation 149 and surface 132 alignment with the detected drinkware 128 throughout the switching process. It should be appreciated that the toolbar 116 can cache multiple augmented-reality object 130 options locally to militate against processing delays during real-time switching operations, ensuring that dynamic content changes can be executed efficiently without degrading video session 136 quality or user experience.

The toolbar 116 can also include GUI features, for example, that allow for the modification of images 140 during active video sessions 136. Users can select from libraries of pre-uploaded images 140 or upload new content dynamically during video sessions 136 to change the appearance of an augmented-reality object 130. The toolbar 116 can support modification requests 170 that enable users to adjust image 140 properties including size, position, rotation, and transparency without interrupting the ongoing video session 136. For example, the toolbar 116 can maintain video session 136 continuity while processing image 140 changes, ensuring that the transition between different images 140 appears smooth and professional to other participants of the video session 136.

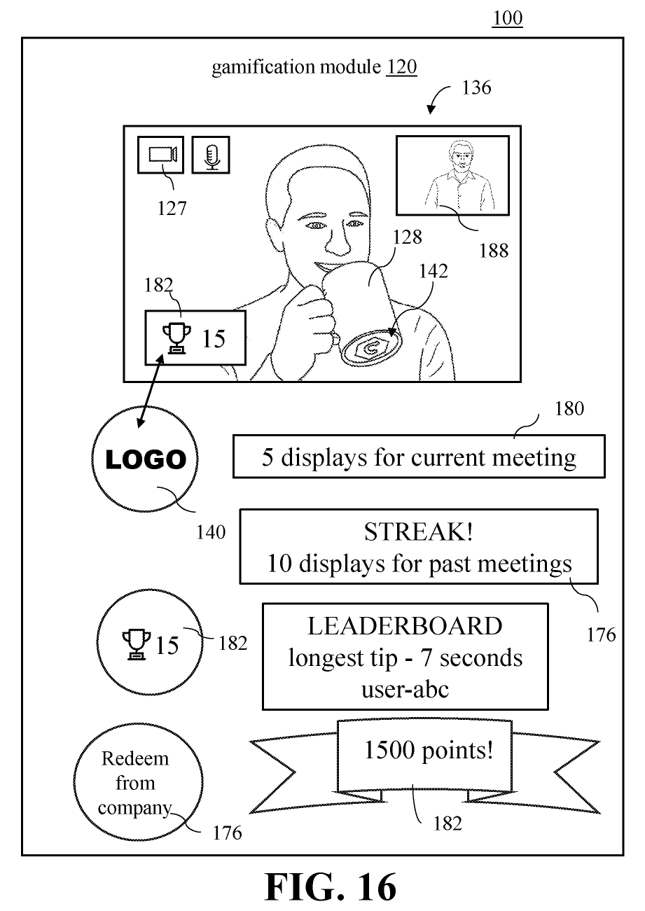

As shown in FIG. 16, the recap screen 118 can provide comprehensive video session 136 analytics and performance metrics 176 following the completion of a video session 136. The recap screen 118 can display detailed information about object detection frequency 174, orientation 149 analysis results, and the duration 172 of successful image 140 viewings or viewer count 180 during each video session 136. For example, the recap screen 118 can present data visualization elements that help users understand the effectiveness and performance characteristics of the augmented reality functionality. For example, the viewer count 180 can include the number of participants in the video session 136, the number of individuals that have live viewing access to the video session 136, the number of “hits” a video session 136 accumulates from online visitors when the video session 136 is posted to a website, social media post, or application, or a combination of these examples to gauge how many individuals see or interact with the augmented-reality object 130 overall. The recap screen 118 can include export capabilities that allow users to save video session 136 data for further analysis or reporting purposes. The recap screen 118 can provide comparative analytics that show performance trends across multiple video sessions 136 and different configuration settings.

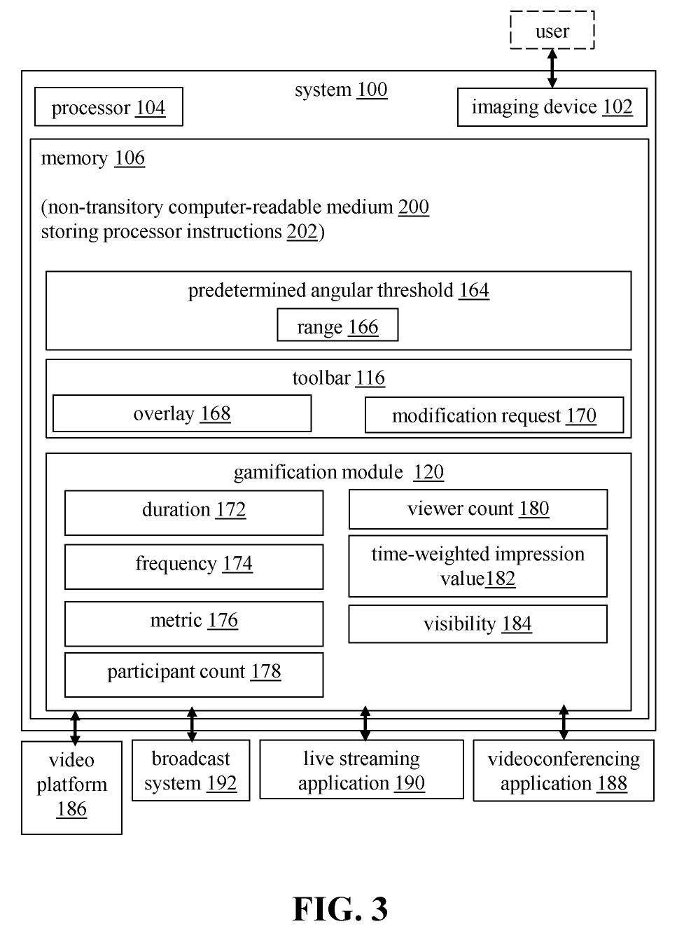

As shown in FIGS. 3, 12, and 16, the gamification module 120 can provide engaging user interaction features that encourage active participation in augmented reality activities. The gamification module 120 can calculate and track various performance metrics 176 including the frequency 174 and duration 172 of successful image 140 displays during video sessions 136. The gamification module 120 can implement leaderboard functionality that allows users to compare the performance against other participants in competitive or collaborative environments. For example, the application can track and generate game elements such as badges or levels, progress bars, virtual currency, leaderboards with comparisons to other participants or high scores, encouraging the user or other participants to lift the drinkware 128 into the image-generating position 134 more frequently than otherwise. The gamification module 120 can provide reward mechanisms including gifts, coupons, discounts associated with the goods or services of the company associated with the predetermined image 140, and promotional links that can be earned based on participation levels and performance achievements. The gamification module 120 can allow for the configuration of various parameters that determine scoring algorithms, achievement thresholds, and reward distribution mechanisms. For example, the gamification module 120 can count and store a number of times that the augmented-reality object 130 is generated for the user, other participants, or audience members during either a single video session 136, or over multiple video sessions 136, or the viewable duration 172 of the augmented-reality object 130 per occurrence or cumulatively. It should be appreciated that the calculations made by the gamification module 120 can allow for user or sponsor invoicing and billing, where the occurrence or cumulative count of a viewable augmented-reality object 130 can be associated with a payment or sponsorship.

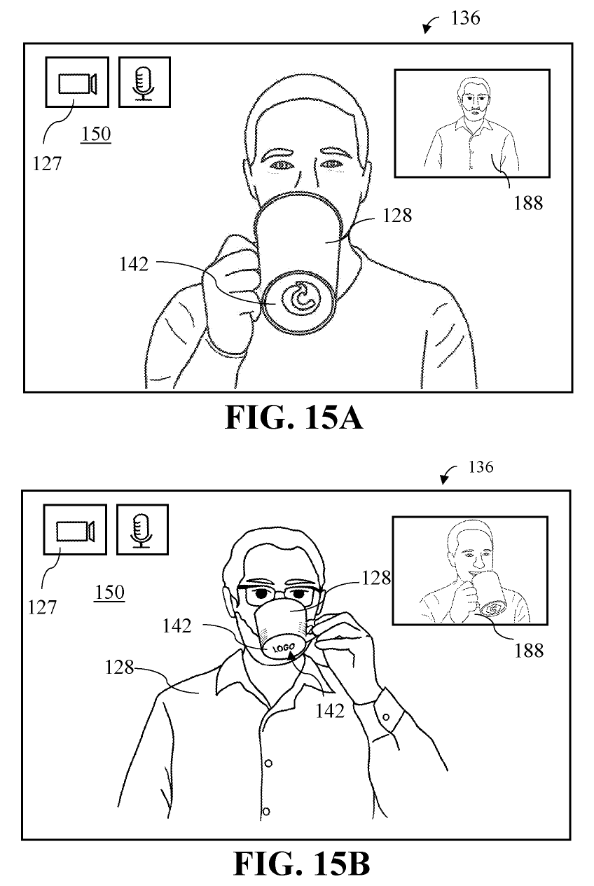

The gamification module 120 can incorporate various engagement mechanisms that can track consecutive performance patterns across multiple video sessions 136, for example, implementing streak-based scoring can reward sustained participation levels over extended periods, as shown in FIG. 16. Alternatively, the gamification module 120 can open a web-based or local application to view a gaming metric 176. The gamification module 120 can calculate a bonus scoring metric 176 when the drinkware 128 orientation 149 reaches optimal positioning angles where the surface 132 can be positioned substantially perpendicular to the imaging device 102, providing enhanced point multipliers for precision-based user interactions. The gamification module 120 can facilitate partnership integrations with local business entities that can provide gift certificates, promotional rewards, or discount incentives based on predetermined logo visibility 184 thresholds achieved during video sessions 136 through the system 100. The gamification module 120 can implement Quick Response (QR) code functionality that can be displayed continuously during video sessions 136, enabling click-through tracking capabilities and website view analytics that can be correlated with a visibility 184 metric 176 of the augmented-reality object 130 to generate comprehensive engagement data. The gamification module 120 can store and analyze QR code interaction patterns alongside traditional visibility 184 duration 172 measurements, creating multi-dimensional performance assessments that can be utilized for enhanced reward distribution algorithms and user engagement optimization within the system 100. The gamification module 120 can generate a viewer-weighted metric 176 that correlates image 140 visibility 184 duration 172 with the number of active participants or viewers during each video session 136. It should be appreciated that the gamification module 120 can integrate with various video platforms 186 including a videoconferencing application 188, live streaming applications 190, and broadcast systems 192, for example, in FIGS. 15A and 15B, and establish communication protocols with supported platforms to obtain participant count 178 information and video session 136 metadata that can be used for analytics and performance measurement.

The compliance module 122 within the memory 106 can ensure that the system 100 operates in accordance with relevant legal, regulatory, and platform-specific requirements. The compliance module 122 can implement data protection measures that safeguard user privacy and ensure appropriate handling of video content and personal information. The compliance module 122 can incorporate audit trail capabilities that track the system 100 usage and maintain records necessary for regulatory compliance and legal verification. The compliance module 122 can enforce content filtering and moderation capabilities to ensure that images 140 meet appropriate standards for professional and commercial environments. The compliance module 122 can provide reporting capabilities that generate compliance documentation and audit reports as required by organizational policies or regulatory frameworks.

The compliance module 122 can comply with specific regulatory frameworks, e.g., the General Data Protection Regulation (GDPR), the California Consumer Privacy Act (CCPA), and applicable advertising standards that govern digital marketing and promotional content display. For example, the compliance module 122 can implement data minimization protocols that can be required under GDPR provisions, ensuring that only necessary user interaction data and a session metric 176 can be collected and processed during augmented reality operations. The compliance module 122 can provide user consent management capabilities that can meet CCPA requirements for data processing transparency and user control over personal information handling. The compliance module 122 can enforce advertising content standards that can be applicable to promotional images 140, ensuring that displayed augmented-reality objects 130 comply with platform-specific advertising policies and industry regulations governing digital content presentation. It should be appreciated that the compliance module 122 can generate automated compliance reports that can be utilized for regulatory audits, data protection impact assessments, and verification of adherence to applicable legal frameworks governing augmented reality advertising.

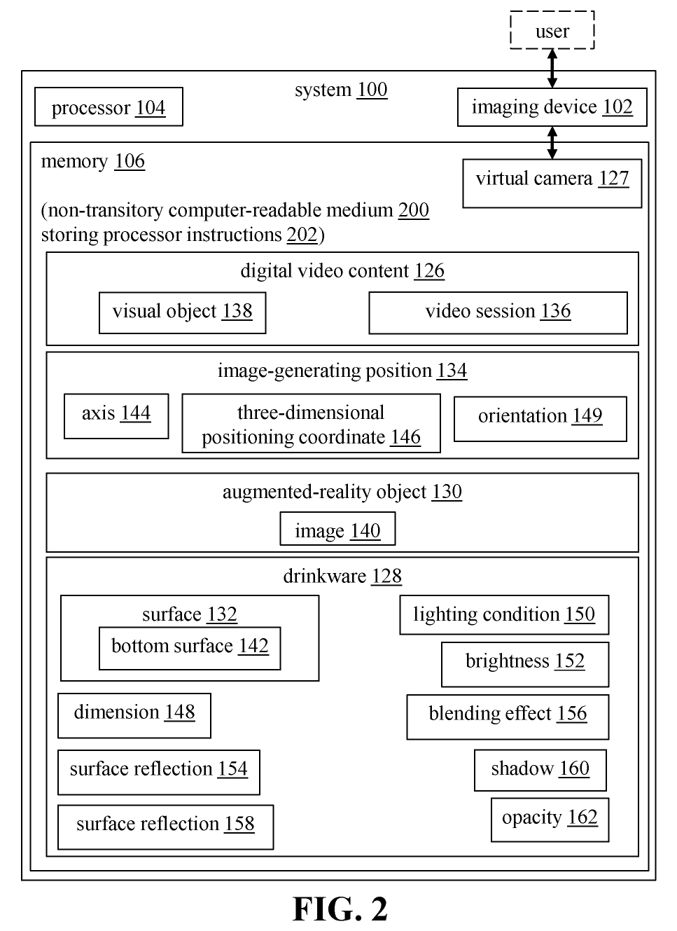

As shown in FIGS. 1 and 2, the database 124 can provide persistent storage capabilities for various types of data including user profiles, image 140 libraries, video session 136 analytics, and configuration settings. The database 124 can be implemented using cloud- based storage solutions that provide scalability, reliability, and accessibility across multiple devices and platforms. The database 124 can store customer relationship management data that enables personalized user experiences and targeted content delivery based on user preferences and historical usage patterns. The database 124 can maintain comprehensive analytics data that supports business intelligence operations and performance optimization activities. The database 124 can implement robust security measures including encryption, access controls, and backup procedures to protect stored data and ensure system 100 reliability. The database 124 can employ retention timelines for specific data, such as storing data relating to video sessions 136 for a certain number of hours or storing aggregate data for a certain number of days. For example, the database 124 can store logs of video sessions 136 for 90 days following the end of the video session 136 for the user to review. It should be appreciated that the database 124 retention timelines can balance operational needs such minimization of data while remaining transparent with billing and regulatory compliance.

The database 124 can be configured in various ways, including: a local database 124 located on the system 100, shown as the database 124 option 1 in FIG. 1; a database 124 saved on a remote server and accessed via the network, labeled as the database 124 option 2 in FIG. 1, such as a cloud server; or a combination of a local and a remote database 124, as configured for a particular system 100. The database 124 can also include, for example, a vector database 124 or vector store for storing vectors generated or utilized by various modules including the detection module 108, the orientation module 110, or the rendering module 112, initialization vectors (IVs), feature vectors, or vector embeddings, e.g., flexible, meaning-based, probabilistic numerical representations of data that capture semantic meaning, allowing the system 100 to compare similarities between different types of data. The database 124 can also include a relational database 124, for example, data saved in a structured form, e.g., a structured query language (SQL) table, a comma-separated values (CSV) file, or in JavaScript object notation (JSON), or a JSON-related object or map, or object storage, or other forms of tabular input. The database 124 can also include a general storage database 124 to store, for example, unstructured data such as HTML, text, raw transcripts, chat logs, images 140, audio files, or social media posts. It should be understood that the database 124 can employ separate or secondary encryptions as required by the system 100, ensuring that stored personal profile and financial-related data remain secure and confidential when later retrieved by the user.

As shown in FIGS. 1-3, a non-transitory computer-readable storage medium 200 is provided, operable to store processor instructions 202 for displaying an augmented-reality object 130 on a drinkware 128 within a digital video content 126 for a user. When the processor instructions 202 are executed by a processor 104, the processor instructions 202 can cause the processor 104 to capture the digital video content 126 via an imaging device 102 and provide the digital video content 126 to a detection module 108. The processor instructions 202 can cause the processor 104 to identify a visual object 138 within the digital video content 126 as the drinkware 128. The processor instructions 202 can cause the processor 104 to identify a surface 132 of the drinkware 128 via a detection module 108. The processor instructions 202 can cause the processor 104 to analyze the drinkware 128 via an orientation module 110 to determine when the drinkware 128 is tilted to an image-generating position 134 where the surface 132 of the drinkware 128 is viewable in the digital video content 126. The processor instructions 202 can cause the processor 104 to overlay or superimpose an image 140 onto the surface 132 of the drinkware 128 via a rendering module 112 when an orientation 149 of the drinkware 128 meets a predetermined angular threshold 164 relative to the imaging device 102.

As shown in FIGS. 17A and 17B, a method 300 for displaying an augmented-reality object 130 on a drinkware 128 within a digital video content 126 for a user is provided. The method 300 can include a step 302 of providing a processor 104, a memory 106 in communication with the processor 104, the memory 106 including the detection module 108, the orientation module 110, the rendering module 112, and the database 124. The imaging device 102 can capture the digital video content 126 and provide the digital video content 126 to the detection module 108. The detection module 108 can receive the digital video content 126 from the imaging device 102, identify a visual object 138 within the digital video content 126 as the drinkware 128, and identify a surface 132 of the drinkware 128. The orientation module 110 can analyze the drinkware 128 to determine when the drinkware 128 is tilted to an image-generating position 134 where the surface 132 of the drinkware 128 is viewable in the digital video content 126. The rendering module 112 can overlay or superimpose an image 140 onto the surface 132 of the drinkware 128 when an orientation 149 of the drinkware 128 meets a predetermined angular threshold 164 relative to the imaging device 102.

The method 300 can include a step 304 of capturing the digital video content 126 via the imaging device 102 and providing the digital video content 126 to the detection module 108. The method 300 can include a step 306 of identifying a visual object 138 within the digital video content 126 as the drinkware 128 and identifying a surface 132 of the drinkware 128 via the detection module 108. The method 300 can include a step 308 of analyzing the drinkware 128 via the orientation module 110 to determine when the drinkware 128 is tilted to an image-generating position 134 where the surface 132 is viewable in the digital video content 126. The method 300 can include a step 310 of overlaying or superimposing an image 140 onto the surface 132 of the drinkware 128 via the rendering module 112 when an orientation 149 of the drinkware 128 meets a predetermined angular threshold 164 relative to the imaging device 102.

As shown in FIG. 18, a method 400 for displaying an augmented-reality object 130 on a drinkware 128 within a digital video content 126 for a user is provided. The method 400 can include steps 302-304 of method 300 (as steps 402-404 respectively). The method 400 can include a step 406 of providing in the memory 106 a dashboard 114 and a gamification module 120, where the dashboard 114 can allow the user to select from one or more images 140 to overlay or superimpose on the surface 132 of the drinkware 128. The method 400 can include a step 408 of receiving the image 140 by the user through the dashboard 114, tracking a visibility 184, a duration 172, and a frequency 174 of the image 140 via the gamification module 120. The method 400 can include a step 410 of generating a compensation metric 176 based on a viewer count 180 during a video session 136 of the digital video content 126. The method 400 can include a step 412 of receiving a modification request 170 from the user to change the image 140 during an active video session 136 of the digital video content 126. The method 400 can include a step 414 of updating the image 140 displayed on the surface 132 of the drinkware 128 based on the modification request 170 from the user. The method 400 can include steps 306-310 of method 300 (as steps 416-420 respectively).

As shown in FIG. 19, a method 500 for displaying an augmented-reality object 130 on a drinkware 128 within a digital video content 126 for a user is provided. The method 500 can include steps 302-310 of method 500 300 (as steps 502-510 respectively). The method 500 can include a step 512 of overlaying or superimposing the image 140 onto the surface 132 that includes calculating a three-dimensional positioning coordinate 146 for a placement of the image 140 and adjusting a dimension 148 of the image 140 to conform to a geometry of the surface 132. The method 500 can include a step 514 of analyzing a lighting condition 150 within the digital video content 126, adjusting an opacity 162, a brightness 152, or a color saturation 154 for the image 140 to match the lighting condition 150. The method 500 can include a step 516 of applying a blending effect 156 that incorporates from the drinkware 128 a surface reflection 158 or a shadow 160.

As shown in FIG. 20, a method 600 for displaying an augmented-reality object 130 on a drinkware 128 within a digital video content 126 for a user is provided. The method 600 can include steps 302-310 of method 300 (as steps 602-610 respectively). The method 600 can include a step 612 of overlaying or superimposing the image 140 onto a bottom surface 142 that includes determining when the predetermined angular threshold 164 can be within a range 166 of 30 degrees to 150 degrees relative to an axis 144 of the imaging device 102. The method 600 can include a step 614 of monitoring the predetermined angular threshold 164 and terminating an image 140 when the predetermined angular threshold 164 falls outside of the range 166 of 30 degrees to 150 degrees relative to the axis 144 of the imaging device 102.

As shown in FIG. 21, a method 700 for displaying an augmented-reality object 130 on a drinkware 128 within a digital video content 126 for a user is provided. The method 700 can include steps 302-306 of method 300 (as steps 702-706 respectively). The method 700 can include a step 708 of detecting a plurality of drinkware 128 within the digital video content 126. The method 700 can include a step 710 of analyzing each drinkware 128 to determine when each drinkware 128 can be tilted to the image-generating position 134. The method 700 can include a step 712 of overlaying or superimposing the image 140 on the surface 132 of each drinkware 128 that independently meets the predetermined angular threshold 164. The method 700 can include steps 308-310 of method 300 (as steps 714-716 respectively).

As shown in FIG. 22, a method 800 for displaying an augmented-reality object 130 on a drinkware 128 within a digital video content 126 for a user is provided. The method 800 can include step 302 of method 300 (as step 802 respectively). The method 800 can include a step 804 of establishing a communication with a video platform 186 including a videoconferencing application 188, a live streaming application 190, or a broadcast system 192. The method 800 can include a step 806 of obtaining a participant count 178 from the video platform 186 and generating a viewer-weighted metric 176 based on a period of visibility 184 and the participant count 178. The method 800 can include a step 808 of utilizing an imaging device 102 that includes a virtual camera 127. The method 800 can include a step 810 of receiving the digital video content 126 from a video platform 186 including a videoconferencing application 188, a live streaming application 190, or a broadcast system 192. The method 800 can include a step 812 of routing the digital video content 126 with the image 140 superimposed on the surface 132 of the drinkware 128 through the virtual camera 127 to the video platform 186. The method 800 can include steps 304-310 of method 300 (as steps 814-820 respectively).

As shown in FIGS. 23A-23C, a method 900 for operating a system 100 for displaying an augmented-reality object 130 on a drinkware 128 is provided. The method 900 can include a step 902 of downloading and installing the system 100, including an imaging device 102 in the form of a virtual camera 127. The method 900 can include a step 904 of registering the virtual camera 127 as a webcam on the local computer of the user. The method 900 can include a step 906 of activating the detection module 108, orientation module 110, and rendering module 112 to run in the background while virtual camera 127 can be used. The method 900 can include a step 908 of selecting the virtual camera 127 for a videoconference platform. The method 900 can include a step 910 of activating virtual camera 127 and capturing a video session 136 and sending captured video session 136 to an augmented reality AR engine. The method 900 can include a step 912 of detecting a shape of a drinkware 128 via the detection module 108 and tracking the orientation 149 of the drinkware 128 via the orientation module 110. The method 900 can include a step 914 of determining if a drinkware 128 can be detected. The method 900 can include a step 916 of calculating the tilt angle of a detected drinkware 128 to determine if tilted angle can be equal to or more than an image-generating position 134. For example, the image-generating position 134 can be equal to or more than 30°. The method 900 can include a step 918 of rendering an augmented-reality object 130 a surface 132 of the drinkware 128 via the rendering module 112 and logging a duration 172 that the augmented-reality object 130 can be visible, a timestamp, and a total number of appearances. The method 900 can include a step 920 of rendering session including the augmented-reality object 130 and sending session to the camera output where the videoconference platform displays the session in a live feed. The method 900 can include a step 922 of determining if video session 136 has ended. The method 900 can include a step 924 of uploading a metric 176 of the video session 136, and caching when the user can be offline. The method 900 can include a step 926 of deactivating the virtual camera 127 and the AR engine.

As shown in FIG. 24, a method 1000 for operating a system 100 for displaying an augmented-reality object 130 on a drinkware 128 is provided. The method 1000 can include steps 902-910 of method 900 (as steps 1002, 1004, 1006, 1008, and 1010 respectively). The method 1000 can include a step 1012 of displaying a dashboard 114 including a toolbar 116. The method 1000 can include a step 1014 of determining user authentication in the background and loading images 140 from a database 124. The method 1000 can include steps 1016-1032 of proceeding to the detection, rendering, and session management steps corresponding to steps 910-926 of method 900. The method 1000 can include a step 1034 of activating a recap screen 118 on the dashboard 114.

As shown in FIGS. 25A-25B, a method 1100 for operating a mobile application for displaying an augmented-reality object 130 on a drinkware 128 is provided. The method 1100 can include a step 1102 of downloading and installing a mobile version of the system 100 and requesting permission the mobile camera of a user. The method 1100 can include a step 1104 of activating mobile camera and activating the detection module 108, orientation module 110, and rendering module 112, and loading augmented-reality object 130. The method 1100 can include a step 1106 of determining whether a drinkware 128 and a surface 132 of the drinkware 128 can be present. The method 1100 can include a step 1108 of calculating the tilt angle of a detected drinkware 128 to determine if tilted angle can be equal to or more than 30°. The method 1100 can include a step 1110 of rendering and continually updating augmented-reality object 130 a surface 132 of the drinkware 128 via the rendering module 112. The method 1100 can include a step 1112 of determining whether video session 136 had ended. The method 1100 can include a step 1114 of uploading a metric 176 of the video session 136.

As shown in FIG. 26, a method 1200 for operating a toolbar 116 and overlay 168 options during a video session 136 is provided. The method 1200 can include a step 1202 of initializing video session 136, including checking for authorization of user, loading images 140, and loading data of the user. The method 1200 can include a step 1204 of initializing a toolbar 116 and providing option to the user for selecting video session 136 overlay 168. For example, the toolbar 116 can include overlay 168 options such as a “login”/”log out”, a “choose logo”, or other “overlays” for the user to select. The method 1200 can include a step 1206 of providing option to user for overlay 168 to remain visible during video session 136. The method 1200 can include a step 1208 of providing option to user for toggling overlay 168 widgets on or off. For example, the widgets can include impressions, e.g., how many times a drinkware 128 was tilted, a QR code, exposure, e.g., total time a drinkware 128 was tilted, a viewer count 180 showing real-time count of users, participants, and other audience members, and post-call statistics after the video session 136 has ended.

Advantageously, the present technology addresses certain limitations in augmented reality systems by providing enhanced object recognition capabilities that can be specifically tailored for detecting drinkware 128 within digital video content 126, thereby overcoming challenges related to visual disconnect between objects and superimposed images 140 that occur when objects change orientation 149 or angle. The present technology determines precise positioning and orientation 149 of a detected drinkware 128 to maintain realistic visual integration, addressing problems that cause cartoonish or unrealistic appearances in certain AR applications while maintaining professional aesthetic quality during videoconferencing and digital content applications. The present technology can seamlessly integrate with prerecorded streams based on optimal viewing angles and surface 132 geometry, eliminating the tedious process of manually selecting virtual backgrounds while providing dynamic methods for presenting contextual information that can be both engaging and professionally appropriate. This present technology overcomes object recognition limitations in varying lighting conditions 150, occlusion, and complex environments by delivering accurate real-time processing capabilities that enable seamless integration of promotional or informational content without compromising the professional nature of videoconferencing settings.

### EXAMPLES

Example embodiments of the present technology are provided with reference to the several figures enclosed herewith.

### Example 1: Video Conference with Sponsor Logo Display

A user participates in a video conference call using the system 100 on a laptop computer. The imaging device 102 accesses the digital video content 126 from the laptop's virtual camera 127 and the detection module 108 performs object recognition to identify a coffee mug held by the user as drinkware 128.

As the user lifts the mug to take a drink, the orientation module 110 detects the changing orientation 149 of the bottom surface 142 of the mug. When the mug reaches an optimal viewing angle within the angular threshold 164 range 166 relative to the imaging device 102, the system 100 determines that the bottom surface 142 can be positioned at an image- generating position 134 where the surface 132 becomes sufficiently viewable within the digital video content 126.

At this point, the rendering module 112 overlays or superimposes an augmented-reality object 130 containing the event sponsor's logo onto the bottom surface 142 of the mug in the video session 136, as shown in FIG. 4, for example. The toolbar 116 enables dynamic logo switching capabilities, allowing the user to transition between different sponsor logos stored in the database 124 during an active videoconferencing application 188. The augmented-reality object 130 can be rendered in real-time to match the three-dimensional positioning coordinate 146 and dimension 148 of the bottom surface 142 as the drinkware 128 moves.

Other participants see the sponsor logo displayed on the user's mug when tilted toward the imaging device 102 at the appropriate orientation 149. As shown in FIG. 12, the gamification module 120 tracks the duration 172 and frequency 174 of successful logo displays during the video session 136, generating a compensation metric 176 based on participant count 178 and viewer count 180. At the session's conclusion, the recap screen 118 displays a time-weighted impression value 182 and period of visibility 184 data that can be utilized for sponsor billing and performance analysis.

### Example 2: Multi-User Product Demonstration

A company hosts a virtual product demonstration for multiple remote participants using a single screen, as shown in FIG. 9. Each participant receives a sample product in a branded tumbler prior to the event. As the presenter guides participants through examining the product, the detection module 108 identifies the tumblers as drinkware 128 for each user's digital video content 126.

When participants pour the product sample from a tumbler, the orientation module 110 detects the changing orientation 149 of the bottom surface 142 of each tumbler. As the tumblers reach the image-generating position 134, the rendering module 112 applies augmented-reality objects 130 displaying product information including nutritional facts and ingredients on the bottom surfaces 142 visible in each participant's video session 136.

The image 140 content displayed can be customized based on the specific product variant each participant received. The rendering module 112 adjusts the augmented-reality objects 130 in real-time to match the lighting condition 150, brightness 152, and color saturation 154 of each tumbler, maintaining natural appearance through blending effects 156 that incorporate surface reflections 158 and shadows 160, for example, in FIGS. 10 and 11.

This allows the presenter to reference specific product details that all participants can view on their respective samples, enhancing engagement during the demonstration. The gamification module 120 tracks visibility 184 duration 172 and frequency 174 for each participant throughout the event, generating comprehensive analytics reports for the marketing team through the database 124 storage capabilities.

### Example 3: Influencer Marketing Campaign

A company partners with a third-party influencer to promote branded content through a sponsored streaming video episode with participating fans. The influencer streams content on a social media live streaming application 190 where the online audience can post in the channel's comment section.

At the beginning of the streaming video episode, the influencer announces to participating fans and the online audience that tracking of logo display frequency 174 on the bottom surface 142 of the tumbler held by the influencer will result in free products for participating fans, as shown in FIG. 12. The influencer further engages the online audience by announcing that posting one product aspect for each logo appearance will earn exclusive coupon codes.

When the influencer raises the tumbler to the image-generating position 134, the system 100 displays the company logo through the rendering module 112 on the bottom surface 142. The gamification module 120 incorporates a Quick Response (QR) code functionality that can be displayed continuously during video sessions 136, enabling click-through tracking capabilities and website view analytics correlated with a visibility 184 metric 176 relating to the augmented-reality object 130.

When the streaming video concludes, the recap screen 118 provides comprehensive analytics including duration 172, frequency 174, and a viewer-weighted exposure metric 176 that enable accurate distribution of products to fans who correctly counted logo appearances, for example, in FIG. 16. The compliance module 122 ensures adherence to advertising standards governing digital marketing content presentation throughout the campaign.

### Example 4: Employment Training Video session 136

A company conducts virtual employment training for new hires using the system 100. Each trainee receives a company-branded water bottle for use during the video session 136. The imaging device 102 accesses video feeds from all participants while the detection module 108 identifies the water bottles as drinkware 128.

Throughout the employment training, the instructor prompts trainees to participate in activities involving the water bottles, for example, as shown in FIG. 7. As trainees lift and tilt the bottles to the image-generating position 134, the orientation module 110 detects when the bottom surfaces 142 become viewable. The rendering module 112 applies augmented-reality objects 130 displaying employment-related content such as policy reminders, safety protocols, and performance indicators on the surface 132 of the bottles.

The system 100 dynamically adjusts the displayed image 140 content through the toolbar 116 interface based on training progress and individual trainee performance data stored in the database 124. When trainees struggle with particular employment concepts, the system 100 can display additional review information when bottles reach optimal orientation 149 angles.

The gamification module 120 implements employment-focused scoring tied to bottle interactions, where trainees earn points for correctly responding to policy questions displayed on bottles, maintaining proper hydration habits during training sessions 136, and achieving participation milestones. The compliance module 122 ensures all displayed content meets employment training regulatory requirements. A leaderboard, as shown in FIG. 16, displayed through the recap screen 188 of the dashboard 114 encourages engagement with employment training materials while providing comprehensive performance analytics for human resources assessment purposes.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments can be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A system for displaying an augmented-reality object on a drinkware within a digital video content for a user, comprising:
an imaging device;
a processor; and
a memory in communication with the processor, the memory including a detection module, an orientation module, and a rendering module;
wherein:
the imaging device is configured to capture the digital video content and provide the digital video content to the detection module;
the detection module is configured to receive the digital video content from the imaging device, identify a visual object within the digital video content as the drinkware, and identify a surface of the drinkware;
the orientation module is configured to analyze the drinkware to determine when the drinkware is tilted to an image-generating position where the surface of the drinkware is viewable in the digital video content; and
the rendering module is configured to overlay an augmented-reality object onto the surface of the drinkware when an orientation of the drinkware meets a predetermined angular threshold relative to the imaging device.

2. The system of claim 1, wherein the augmented-reality object includes an image, and the memory further includes a dashboard configured to receive an image.

3. The system of claim 2, wherein the dashboard is further configured to allow the user to select from one or more images for use as an augmented-reality object to overlay on the surface of the drinkware, receive a modification request from the user to change the one or more images during an active video session of the digital video content, and update the one or more images used as the augmented-reality object displayed on the surface of the drinkware based on the modification request from the user.

4. The system of claim 1, wherein the memory further includes a gamification module configured to track a visibility duration and a frequency of the augmented-reality object, record a viewer count during a video session of the digital video content, and generate a compensation metric based on a viewer count during a video session of the digital video content.

5. The system of claim 4, wherein the gamification module is further configured to correlate the visibility duration and the frequency of the augmented-reality object with the viewer count to generate a viewer-weighted exposure metric, wherein the visibility duration is multiplied by the viewer count to produce a time-weighted impression value.

6. The system of claim 1, wherein the rendering module is further configured to analyze a lighting condition within the digital video content, adjust a brightness and a contrast of the augmented-reality object to match the lighting condition, and apply a blending effect that incorporates from the drinkware a member selected from a group consisting of a surface reflection, a shadow, and combinations thereof.

7. The system of claim 1, wherein the surface includes a bottom surface, the predetermined angular threshold includes a range of 30 degrees to 150 degrees relative to an axis of the imaging device, and the image-generating position occurs when a portion of the bottom surface is viewable.

8. The system of claim 7, wherein the rendering module is further configured to monitor the predetermined angular threshold and terminate an overlaying of the augmented-reality object when the predetermined angular threshold falls outside of the range of 30 degrees to 150 degrees relative to the axis of the imaging device.

9. The system of claim 1, wherein the detection module is further configured to simultaneously identify a plurality of drinkware within the digital video content, and the rendering module is further configured to overlay the augmented-reality object onto the surface of each drinkware when the orientation of each drinkware independently meets the predetermined angular threshold.

10. The system of claim 1, wherein the rendering module is further configured to adjust a member selected from a group consisting of an opacity, a brightness, a color saturation, and combinations thereof for the augmented-reality object based on a lighting condition detected in the digital video content.

11. A method for displaying an augmented-reality object on a drinkware within a digital video content for a user, comprising:
providing an imaging device, a processor and a memory in communication with the processor, the memory including a detection module, an orientation module, and a rendering module,
wherein:
the imaging device is configured to capture the digital video content and provide the digital video content to the detection module,
the detection module is configured to receive the digital video content from the imaging device, identify a visual object within the digital video content as the drinkware, and identify a surface of the drinkware,
the orientation module is configured to analyze the drinkware to determine when the drinkware is tilted to an image-generating position where the surface of the drinkware is viewable in the digital video content, and
the rendering module is configured to overlay an augmented-reality object onto the surface of the drinkware when an orientation of the drinkware meets a predetermined angular threshold relative to the imaging device;
capturing the digital video content via the imaging device and providing the digital video content to the detection module;
identifying the visual object within the digital video content as the drinkware and identifying the surface of the drinkware via the detection module;
analyzing the drinkware via the orientation module to determine when the drinkware is tilted to the image-generating position where the surface is viewable in the digital video content; and
overlaying the augmented-reality object onto the surface of the drinkware via the rendering module when the orientation of the drinkware meets the predetermined angular threshold relative to the imaging device.

12. The method of claim 11, wherein:
the memory further includes a dashboard and a gamification module;
the augmented-reality object includes an image; and
the method further comprises:
receiving the image by the user through the dashboard;
tracking a visibility, a duration, and a frequency of the image via the gamification module; and
generating a compensation metric based on a viewer count during a video session of the digital video content.

13. The method of claim 12, further comprising:
providing in the memory a dashboard configured to allow the user to select from one or more images to overlay on the surface of the drinkware;
receiving a modification request from the user to change the image during an active video session of the digital video content; and
updating the image displayed on the surface of the drinkware based on the modification request from the user.

14. The method of claim 11, wherein overlaying the augmented-reality object onto the surface includes calculating a three-dimensional positioning coordinate for a placement of the augmented-reality object and adjusting a dimension of the augmented-reality object to conform to a geometry of the surface.

15. The method of claim 11, further comprising:
detecting a plurality of drinkware within the digital video content;
analyzing each drinkware to determine when each drinkware is tilted to the image-generating position; and
overlaying the augmented-reality object on the surface of each drinkware that independently meets the predetermined angular threshold.

16. The method of claim 11, further comprising:
establishing a communication with a video platform selected from a group consisting of a videoconferencing application, a live streaming application, a broadcast system, and combinations thereof;
obtaining a participant count from the video platform; and
generating a viewer-weighted metric based on a period of visibility and the participant count.

17. The method of claim 11, wherein:
the surface includes a bottom surface; and
the method further comprises:
overlaying the augmented-reality object onto the bottom surface includes determining when the predetermined angular threshold is within a range of 30 degrees to 150 degrees relative to an axis of the imaging device;
monitoring the predetermined angular threshold; and
terminating an overlay of the augmented-reality object when the predetermined angular threshold falls outside of the range of 30 degrees to 150 degrees relative to the axis of the imaging device.

18. The method of claim 11, further comprising:
analyzing a lighting condition within the digital video content;
adjusting a member selected from a group consisting of an opacity, a brightness, a color saturation, and combinations thereof for the augmented-reality object to match the lighting condition; and
applying a blending effect that incorporates from the drinkware a member selected from a group consisting of a surface reflection, a shadow, and combinations thereof.

19. The method of claim 11, wherein:
the imaging device includes a virtual camera; and
the method further comprises:
receiving the digital video content from a video platform selected from a group consisting of a videoconferencing application, a live streaming application, a broadcast system, and combinations thereof; and
routing the digital video content with the augmented-reality object overlayed on the surface of the drinkware through the virtual camera to the video platform.

20. A non-transitory computer-readable storage medium, operable to store processor instructions for displaying an augmented-reality object on a drinkware within a digital video content for a user that, when the processor instructions are executed by a processor, causes the processor to:
capture the digital video content via an imaging device and provide the digital video content to a detection module;
identify a visual object within the digital video content as a drinkware, and identify a surface of the drinkware via a detection module;
analyze the drinkware via an orientation module to determine when the drinkware is tilted to an image-generating position where the surface of the drinkware is viewable in the digital video content; and
overlay an augmented-reality object onto the surface of the drinkware via a rendering module when an orientation of the drinkware meets a predetermined angular threshold relative to the imaging device.
